(19) United States
(12) Patent Application Publication
(10) Pub. No.: US 2024/0338773 A1
(43) Pub. Date: Oct. 10, 2024

(54) SYSTEMS AND METHODS FOR AUTOMATIC CONDITION DETERMINATION FOR CLAIM ADJUDICATION

(71) Applicant: Synchrony Bank, Stamford, CT (US)

(72) Inventor: Andrew Haws, Stamford, CT (US)

(21) Appl. No.: 18/623,105

(22) Filed: Apr. 1, 2024

Related U.S. Application Data
(60) Provisional application No. 63/494,281, filed on Apr. 5, 2023.

(51) Int. Cl. G06Q 40/08; G06N 20/00

(52) U.S. Cl. CPC G06Q 40/08; G06N 20/00

(57) ABSTRACT

Systems and methods provide a framework through which one or more machine learning algorithms and programmatic logic are implemented to dynamically, and in real-time, process incoming invoices and corresponding claims as these invoices are received to identify one or more conditions for which treatment was provided. Based on these identified one or more conditions, as well as any known historical data corresponding to the claimant, adjudication of the invoices and corresponding claims may be performed.

### CROSS-REFERENCE TO RELATED APPLICATIONS

The present patent application claims the priority benefit of U.S. provisional patent application No. 63/494,281 filed Apr. 5, 2023, the disclosures of which are incorporated by reference herein.

### FIELD

The present disclosure relates generally to a framework through which machine learning algorithms and logic are dynamically trained and implemented to automatically detect conditions for the adjudication of submitted claims.

### SUMMARY

Disclosed embodiments provide systems and methods for automatically detecting, from provided invoices or other transaction notifications, different conditions for adjudication of submitted claims. According to some embodiments, a computer-implemented method is provided. The computer-implemented method comprises receiving an invoice associated with an insured entity. The invoice indicates a set of procedures performed for treatment of the insured entity. Further, the insured entity is associated with a policy. The computer-implemented method further comprises generating a digitized version of the invoice. The digitized version of the invoice is generated according to a machine-readable format. The computer-implemented method further comprises dynamically training a machine learning algorithm to identify one or more conditions associated with the invoice. The machine learning algorithm is dynamically trained using a dataset of historical invoices and corresponding conditions. The computer-implemented method further comprises identifying the one or more conditions associated with the invoice. The one or more conditions are identified through the machine learning algorithm using the digitized version of the invoice. The computer-implemented method further comprises generating an adjudication of a set of claims associated with the invoice. The adjudication is generated based on the one or more conditions and the policy. The computer-implemented method further comprises updating the machine learning algorithm using the invoice, the one or more conditions, and the adjudication.

In some embodiments, the digitized version of the invoice is generated using an optical character recognition (OCR) process.

In some embodiments, the adjudication includes a rejection of the set of claims. Further, the rejection of the set of claims is generated as a result of the one or more conditions corresponding to a set of pre-existing conditions associated with the insured entity.

In some embodiments, the computer-implemented method further comprises applying a logic process to the digitized version of the invoice to obtain a set of condition tags corresponding to different conditions. The set of condition tags are associated with a set of confidence scores. The computer-implemented method further comprises processing the digitized version of the invoice through the machine learning algorithm as a result of the set of confidence scores failing to satisfy a minimum threshold value.

In some embodiments, the one or more conditions are identified through identification of a proximate cluster from a set of clusters. The proximate cluster corresponds to the one or more conditions. Further, the proximate cluster is identified according to a set of vector values corresponding to parameters associated with the invoice.

In some embodiments, the machine learning algorithm is further updated according to modifications made to previous adjudications resulting from appeals made to the previous adjudications.

In some embodiments, updating the machine learning algorithm includes modifying one or more variables corresponding to a set of vectors of similarity corresponding to parameters associated with the historical invoices according to the adjudication.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a claims adjudication service, through one or more machine learning algorithms and processing logic, automatically process incoming invoices to identify corresponding conditions and to adjudicate claims corresponding to the incoming invoices according to identified conditions in accordance with at least one embodiment;

FIG. 2 shows an illustrative example of an environment in which parameters corresponding to an obtained invoice are dynamically and automatically processed through an invoice processing module and/or condition determination algorithm to identify any relevant conditions for claims adjudication associated with the invoice in accordance with at least one embodiment;

FIG. 3 shows an illustrative example of an environment in which a condition determination algorithm is dynamically trained in real-time to process invoice parameters to determine one or more conditions corresponding to received invoices for adjudication of claims associated with the received invoices in accordance with at least one embodiment;

FIG. 4 shows an illustrative example of a process for digitizing a received invoice and identifying relevant parameters from the digitized invoice for condition identification and claim adjudication in accordance with at least one embodiment;

FIG. 5 shows an illustrative example of a process for analyzing a digitized invoice and corresponding parameters to identify one or more conditions according to applicable confidence thresholds for claim adjudication in accordance with at least one embodiment;

FIG. 6 shows an illustrative example of a process for analyzing a digitized invoice and corresponding parameters to identify one or more proximate clusters through which one or more conditions can be identified for claim adjudication in accordance with at least one embodiment;

FIG. 7 shows an illustrative example of a process for adjudicating one or more claims in real-time as invoices are received according to identified conditions in accordance with at least one embodiment; and

FIG. 8 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework through which one or more machine learning algorithms and programmatic logic are implemented to dynamically, and in real-time, process incoming invoices and corresponding claims as these invoices are received to identify one or more conditions for which treatment was provided. Based on these identified one or more conditions, as well as any known historical data corresponding to the claimant, adjudication of the invoices and corresponding claims may be performed.

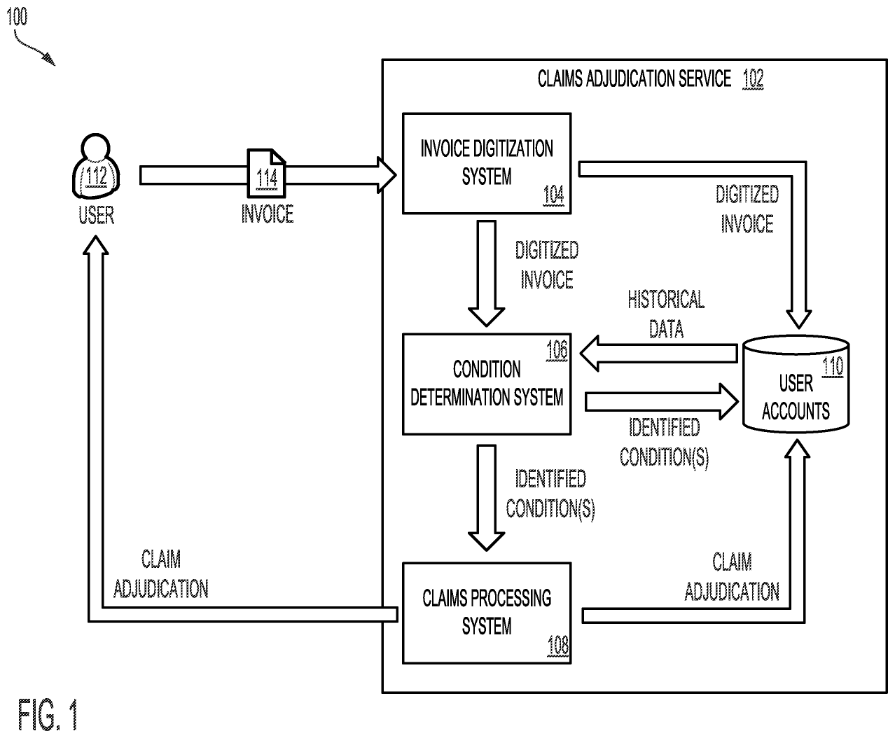

FIG. 1 shows an illustrative example of an environment 100 in which a claims adjudication service 102, through one or more machine learning algorithms and processing logic, automatically process incoming invoices 114 to identify corresponding conditions and to adjudicate claims corresponding to the incoming invoices 114 according to identified conditions in accordance with at least one embodiment. In the environment 100, a user 112 may submit an existing invoice 114 corresponding to treatments and procedures performed for which the user 112 may wish to be reimbursed subject to an existing medical coverage plan. For instance, the user 112 may have an existing medical coverage plan associated with a particular coverage provider (e.g., insurance provider, healthcare provider, etc.). The medical coverage plan may include coverage for human treatments and procedures, veterinary treatments and procedures, cosmetic procedures, dental treatments and procedures, therapeutic procedures, and the like. In some instances, the medical coverage plan may require the user 112 to provide upfront payment to a provider (e.g., doctor, veterinarian, etc.) and subsequently submit a corresponding invoice 114 to a claims adjudication service 102 for reimbursement of this upfront payment according to the parameters associated with the user's existing medical coverage plan.

In an embodiment, the invoice 114 is a physical or electronic document that indicates any treatments and/or procedures performed for the benefit of the user 112 or other entity associated with the user 112 (e.g., a dependent, a pet, etc.). For instance, the invoice 114 may indicate any medications provided to the user 112 by the provider at the time of the performance of the treatments and/or procedures. In some instances, the invoice 114 may additionally, or alternatively, indicate any prescriptions provided to the user 112 for medications that are to be applied for the treatment of one or more conditions. The invoice 114, in some examples, may further include additional notes or documentation corresponding to any medication or treatment plans that are to be followed for any underlying conditions. The invoice 114 can further include identifying information associated with the user 112 or other entity for which the invoice 114 was created. For instance, the invoice 114 may provide the user's name, date of birth, address, contact information, and the like. If the treatments and/or procedures were performed for the benefit of an entity other than the user 112, the invoice 114 may indicate the other entity's name, date of birth, address, contact information (if applicable), and the like. In some examples, the invoice 114 may further include identifying information associated with the provider of the treatments and/or procedures performed (e.g., doctor's name, doctor's address, doctor's contact information, doctor's licensing information, etc.).

Invoices, such as invoice 114, may not be uniform in nature. For instance, invoices generated by a particular provider (e.g., doctor, veterinarian, etc.) may differ from invoices generated by other providers. As an illustrative example, a particular provider may implement a set of codes corresponding to different conditions for which treatments and/or procedures may be performed by the particular provider. This set of codes may be included within the particular provider's invoices along with descriptions of the treatments and/or procedures performed. However, this set of codes may be unique to the particular provider, whereby other providers may use different codes or no codes at all when describing the treatments and/or procedures performed for different conditions. This lack of uniformity may make it difficult for the insurance policy provider to identify the conditions for which treatments and/or procedures were performed from received invoices. This difficulty traditionally results in delays in adjudicating claims for reimbursement of upfront expenses incurred by policy holders, as policy providers may be required to perform added investigations to determine the underlying conditions for which the specified treatments and/or procedures were performed.

The user 112, in some examples, may be a policyholder of an insurance policy for which certain medical treatments and/or procedures may be covered subject to any deductibles defined in the policy. In some instances, the insurance policy may not be applicable for pre-existing conditions that may have been known to the user 112 and to the policy provider at the time of the issuance of the insurance policy. For example, the insurance policy provider may automatically deny any claims for reimbursement related to treatments and/or procedures associated with conditions that pre-dated the issuance of the insurance policy. In some instances, the insurance policy may provide reduced coverage for pre-existing conditions, whereby users may be provided with limited or reduced reimbursement for treatments and/or procedures associated with these pre-existing conditions.

In an embodiment, the user 112 submits an invoice 114 to an invoice digitization system 104 implemented by a claims adjudication service 102 to request reimbursement of upfront expenses incurred by the user 112 for treatments and/or procedures performed. The request for reimbursement may include the invoice 114 and additional information that may be used to identify a corresponding policy associated with the user 112. For instance, when submitting an invoice 114 for reimbursement, the claims adjudication service 102 may prompt the user 112 to provide identifying information associated with the user 112 or other entity associated with the corresponding insurance policy. For instance, the user 112 may be prompted to provide an identifier corresponding to the insurance policy (e.g., policy number, etc.), the name of the policy holder (e.g., name of the user 112, name of the entity insured, etc.), and the like. It should be noted that, in some instances, the user 112 may not be required to provide additional information along with the invoice 114, as the invoice 114 may include sufficient identifying information associated with the user 112 and/or the entity insured to identify a corresponding insurance policy.

The claims adjudication service 102 may be associated with the insurance policy provider. For instance, the claims adjudication service 102 may be implemented by the insurance policy provider to dynamically, and automatically, process incoming claims for reimbursement in real-time subject to applicable policies and corresponding terms. The claims adjudication service 102, as such, may have access to other systems implemented by the insurance policy provider (e.g., user/policy holder databases, payment systems, etc.). In some instances, the claims adjudication service 102 may be implemented by a third-party, whereby the claims adjudication service 102 may be required to access insurance policy provider systems through a communications network (such as the Internet) or through one or more application programming interfaces (APIs) exposed by the insurance policy provider to the claims adjudication service 102 according to the relationship between the insurance policy provider and the provider of the claims adjudication service 102 (such as through a set of credentials, cryptographic keys, etc.). The claims adjudication service 102 may be implemented on a set of computer systems or other systems (e.g., servers, virtual machine instances, etc.). In some instances, the claims adjudication service 102 may be implemented as a set of applications or other executable processes executed on one or more computing systems associated with the insurance policy provider or third-party that implements the claims adjudication service 102.

In an embodiment, the invoice digitization system 104 automatically processes the invoice 114 to generate a digitized version of the invoice 104 and to identify any corresponding parameters that may be used to identify the treatments and/or procedures performed, as well as the underlying conditions for which the treatments and/or procedures were performed, for adjudication of the user's claims. The invoice digitization system 104 may be implemented on a computer system or other system (e.g., server, virtual machine instance, etc.) associated with the claims adjudication service 102. Alternatively, the invoice digitization system 104 may be implemented as an application or other executable process executed on one or more computer systems associated with the claims adjudication service 102.

In an embodiment, the invoice digitization system 104 implements an optical character recognition (OCR) process to convert received invoices into digitized versions of these invoices. The OCR process executed by the invoice digitization system 104 may scan a received invoice, such as invoice 114, to automatically and in real-time identify any text included in the invoice and, accordingly, generate digitized version of the invoice that is machine-readable (e.g., a system can discern textual elements from the digitized version of the invoice). As an illustrative example, if a user 112 submits a physical copy of the invoice 114 to the invoice digitization system 104, the invoice digitization system 104 may perform an initial scan of the invoice 114 to generate an electronic version of the invoice 114. However, this electronic version of the invoice 114 may initially only include a digital image of the invoice 114 that is not searchable or editable. Accordingly, the invoice digitization system 104 may execute an OCR process on the electronic version of the invoice 114 to identify the text included in the electronic version of the invoice 114 and to generate the searchable digitized invoice. Similarly, if the user 112 submits an electronic version of the invoice 114 themselves, the invoice digitization system 104 may execute the aforementioned OCR process on the electronic version of the invoice 114 submitted by the user 112 to identify the text included in the electronic version of the invoice 114 and to generate a searchable, digitized version of the invoice 114.

In an embodiment, the invoice digitization system 104 implements a machine learning algorithm or artificial intelligence that is dynamically trained to process the received invoice 112 to extract any elements from the invoice 114 that may be useful in identifying any underlying conditions for which indicated treatments and/or procedures were performed. For example, the machine learning algorithm or artificial intelligence implemented by the invoice digitization system 104 can include one or more natural language processing (NLP) algorithms that may automatically process a digitized invoice in real-time as these digitized invoices are generated from received invoices to identify any relevant terms corresponding to treatments and/or procedures performed. For instance, the one or more NLP algorithms may be dynamically trained to extract any terms corresponding to drug entities from invoice line items. Further, the one or more NLP algorithms may be dynamically trained to extract drug, treatment, and symptom entities from any first notice of loss (FNOL) diagnosis entries in digitized invoices.

As used herein, NLP is a mechanism whereby computational systems such as those described herein may be used to process and analyze language (from text sources) that is natural (i.e., unstructured). In such systems, the result of the analysis may enable the NLP algorithms to generate insights (i.e., information) about the contents of the source communications and, by extension, about other communications that are in the same language. In such systems, the result of the analysis may enable the NLP algorithms to categorize and/or provide metadata about the source communications and/or about other communications. Being able to both understand and categorize natural language enables a system (e.g., the invoice digitization system 104, etc.) to generate better and/or more accurate insights from natural language and may provide a basis for a system that can receive natural language, understand it, and respond in a reasonable manner. As the NLP algorithms process and analyze a larger set of natural language sources (e.g., digitized invoices, etc.), the quality of the understanding and interaction may improve. Examples of NLP algorithms include, but are not limited to, rule-based NLP (also referred to as “symbolic” NLP and based on sets of applied rules), statistical NLP (generally implemented with unsupervised and/or semi-supervised statistical analyses of unstructured data), and Neural NLP (based on representation learning and deep-learning artificial intelligence techniques). As may be contemplated, when analyzing text sources for NLP, systems can directly input the text into the analysis system.

In an embodiment, the invoice digitization system 104, through the OCR process or through other information provided by the user 112 when submitting the invoice 114 (e.g., identifying information associated with the user 112 or other entity subject to an applicable policy, identifying information corresponding to the applicable policy, etc.), can store the digitized invoice within a user accounts datastore 110. The user accounts datastore 110 may include unique entries corresponding to different users associated with the claims adjudication service 102. For instance, the user accounts datastore 110 may include an entry corresponding to the user 112 that has submitted an invoice 114 and corresponding claims for adjudication by the claims adjudication service 102. This entry may include identifying information associated with the user 112, information corresponding to any policies associated with the user 112 or other entity affiliated with the user 112 (e.g., dependents, pets, etc.), information corresponding to pre-existing conditions associated with the user 112 or other entity affiliated with the user 112, any previously submitted invoices (original and digitized) and corresponding claims, adjudications made by the claims adjudication service 102 corresponding to the previously submitted invoices and claims, any available medical records, and the like. Thus, the invoice digitization system 104 may incorporate the invoice 114 and the digitized version of the invoice 114 into the entry corresponding to the user 112.

In addition to storing the invoice 114 and the digitized version of the invoice 114 into the entry corresponding to the user 112, the invoice digitization system 104 may automatically transmit the digitized invoice and the elements from the invoice 114 that may be useful in identifying any underlying conditions for which indicated treatments and/or procedures were performed to the condition determination system 106. The condition determination system 106 may be implemented on a computer system or other system (e.g., server, virtual machine instance, etc.) associated with the claims adjudication service 102. Alternatively, the condition determination system 106 may be implemented as an application or other executable process executed on one or more computer systems associated with the claims adjudication service 102. As described in greater detail herein, the condition determination system 106 may be configured to dynamically, and in real-time, process digitized invoices and corresponding elements associated with different claims submitted to the claims adjudication service 102 as these claims are received and initially processed by the invoice digitization system 104.

In an embodiment, the condition determination system 106 processes the digitized invoice and corresponding elements identified by the invoice digitization system 104 through an initial data structure to determine whether the elements identified from the digitized invoice correspond to a particular condition associated with the user 112 or other entity affiliated with the user 112 and for which the indicated treatments and/or procedures were performed. The initial data structure may include a mapping of particular elements and/or element combinations to known conditions. For example, a combination of particular elements (e.g., certain pharmaceuticals, certain therapies, etc.) identified from the invoice 114 may correspond to a known treatment regimen for a hip dysplasia condition. Accordingly, the data structure may include a mapping of this combination of particular elements to “hip dysplasia.” In an embodiment, in order for a condition to be definitively identified from the data structure, the condition determination system 106 can be required to identify a particular condition for all of the identified elements specified in the invoice 114. For example, if the condition determination system 106 determines that all of the identified elements from the invoice 114 are not mapped to a particular condition or set of conditions within the data structure, the condition determination system 106 may determine that a condition could not be definitively identified for the invoice 114 using the data structure.

In an embodiment, if the condition determination system 106 is unable to identify one or more conditions for the user 112 or other entity affiliated with the user 112 that is the subject of the invoice 114 through the initial data structure, the condition determination system 106 may process the digitized invoice and corresponding elements using a keyword-based logic process to attempt identification of a set of conditions for which the indicated treatments and/or procedures were provided. The keyword-based logic may be dynamically configured to assign a set of tags to different elements identified from the digitized invoice. Further, the keyword-based logic may assign, to each tag, a confidence score that may be used to denote the level of confidence in the accuracy of the tag assignment to the corresponding element. The keyword-based logic process, in some instances, may rely on one or more automated tagging techniques, such as Named Entity Recognition (NER) tagging. NER tagging may allow the condition determination system 106 to extract named entities from the digitized invoice and, more specifically, from the keywords identified by the invoice digitization system 104, as described above. These named entities may then be classified into pre-defined classes corresponding to different conditions for which claim adjudications may be performed.

The confidence scores assigned to the assigned tags may be used to determine which assigned tags may be associated with the digitized invoice and used for adjudication of the claims associated with the digitized invoice. For instance, a higher confidence score assigned to a particular tag may denote a greater confidence in the accuracy of the tag identification (e.g., identification of a particular condition) performed using NER or other keyword-based logic. In an embodiment, the condition determination system 106, using the keyword-based logic process, can determine whether the confidence score for each assigned tag is greater than a minimum threshold value. For example, any assigned tags having a confidence score below this minimum threshold value may be automatically ignored and, thus, does not become associated with the digitized invoice. As these assigned tags may correspond to different possible conditions for which claim adjudications may be performed, any conditions for which assigned tags fail to satisfy this minimum threshold value may be ignored or disregarded.

In an embodiment, the keyword-based logic process can be dynamically tuned over time as additional data points (e.g., claims adjudications for different invoices, actual identified conditions from these different invoices, etc.) are obtained. For example, tags (e.g., conditions) and corresponding confidence scores, as well as the original digitized invoices and identified keywords, may be evaluated to determine whether the keyword-based logic process is accurately assigning conditions to the keywords identified in the digitized invoices. For example, if the keyword-based logic process assigns a high confidence score to a condition that has been assigned to a digitized invoice based on a particular set of keywords identified by the invoice digitization system 104, and it is determined through later claim adjudication that the assigned condition does not actually correspond to the digitized invoice (such as through evaluation of medical records, through an appeals process, etc.), the keyword-based logic process may be adjusted to reduce the likelihood (e.g., confidence score) for similar classifications of keywords and digitized invoices.

In some instances, the keyword-based logic process may be unable to assign any tags (e.g., conditions) to the digitized invoice as a result of the corresponding confidence scores being below the minimum threshold value. Accordingly, the condition determination system 106 may process the digitized invoice and corresponding keywords through a machine learning algorithm or artificial intelligence dynamically trained, in real-time, to identify one or more conditions associated with digitized invoices. The machine learning algorithm or artificial intelligence implemented by the condition determination system 106 may be dynamically trained in real-time using unsupervised learning techniques. For instance, a dataset of sample digitized invoices and corresponding keywords (e.g., historical invoices and keywords, hypothetical or artificial invoices and keywords, etc.) from the user accounts datastore 110 may be analyzed using a clustering or classification algorithm to classify the digitized invoices and corresponding keywords according to a set of different classifications (e.g., conditions). For instance, the machine learning algorithm or artificial intelligence may be dynamically trained in real-time by classifying the digitized invoices and corresponding keywords according to one or more vectors of similarity between the digitized invoices/keywords and other clusters of digitized invoices corresponding to different conditions associated with the condition determination system 106. Thus, in some embodiments, the condition determination system 106, through the machine learning algorithm or artificial intelligence, can perform such clustering and obtain partial matches among other clusters of digitized invoices according to these one or more vectors to identify a particular cluster and, from this cluster, identify the one or more conditions that may be associated with a received digitized invoice. Example clustering algorithms that may be trained using this dataset may include k-means clustering algorithms, fuzzy c-means (FCM) algorithms, expectation-maximization (EM) algorithms, hierarchical clustering algorithms, density-based spatial clustering of applications with noisc (DBSCAN) algorithms, and the like.

In an embodiment, the different vectors correspond to input data fields identified from digitized invoices by the invoice digitization system 104. For instance, the one or more vectors may correspond to particular pharmaceutical entities extracted from invoice line items. These pharmaceutical entities may correspond to different treatments and/or procedures performed as indicated on the digitized invoices, serving as an indication of underlying conditions being treated. Additionally, one or more vectors from the set of vectors may correspond to user or other entity characteristics. For instance, if the digitized invoices correspond to veterinary treatments and/or procedures, whereby the claim adjudications correspond to insurance policies obtained for pets, the one or more vectors may correspond to pet characteristics. These pet characteristics may include, but are not limited to, the pet species, the pet breed, the pet gender, the pet age at the time of the claim, the pet age at the time of policy enrollment, and the like. Further, the one or more vectors may further include demographic information associated with these pets including, but not limited to, location (e.g., zip code, etc.), climate zone, and rurality. These particular vectors may be associated with clusters corresponding to different conditions codes or types. These condition codes or types may be assigned to conditions according to diagnoses extracted from diagnosis reports and medical records provided by end users. These reports and records may further indicate any symptoms and corresponding treatments and/or procedures performed based on the diagnoses. This data may be used to generate corresponding clusters and to define the different vectors of similarity usable to identify proximate clusters for a given invoice.

In an embodiment, to dynamically train the machine learning algorithm or artificial intelligence used to identify one or more conditions associated with digitized invoices, the condition determination system 106 generates an initial iteration of the machine learning algorithm or artificial intelligence. For instance, the condition determination system 106 may initialize a set of coefficients {α1, α2, α3, . . . αn} randomly according to a Gaussian distribution with low variance centered around zero. Using this initial iteration of the machine learning algorithm or artificial intelligence, the condition determination system 106 may process the dataset of sample digitized invoices and corresponding keywords to generate an output. This output may specify, for each sample digitized invoice and corresponding keyword(s) included in the dataset, an indication of one or more conditions that may be associated with the digitized invoice. The condition determination system 106 may compare the output generated using the initial iteration of the machine learning algorithm or artificial intelligence to the sample conditions defined in the dataset for each of the data points (e.g., sample digitized invoices and corresponding keywords) to identify any inaccuracies or other errors.

If the output of the machine learning algorithm or artificial intelligence does not satisfy one or more criteria, the condition determination system 106 may iteratively update one or more coefficients of the set of coefficients to generate an updated machine learning algorithm or artificial intelligence. For instance, the one or more criteria may include a threshold for the accuracy of the desired machine learning algorithm or artificial intelligence for identifying different conditions from provided invoices. The updated machine learning algorithm or artificial intelligence may be used to process the aforementioned training dataset, as well as any additional data points or other datasets provided by the claims adjudication service 102 or other entity (e.g., a medical services provider, etc.) to generate a new output for each data point in the training dataset. In some instances, the condition determination system 106 may use an optimization algorithm to iteratively update the one or more coefficients of the set of coefficients associated with the machine learning algorithm or artificial intelligence. For instance, the condition determination system 106 may use gradient descent to update the logistic coefficients of the machine learning algorithm or artificial intelligence to generate new cutoff values that may be used to classify the data points of the previously evaluated dataset and of any new data points obtained by the condition determination system 106. The condition determination system 106 may use this updated machine learning algorithm or artificial intelligence to process the available data points and generate a new output. The condition determination system 106 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, if the output generated by the machine learning algorithm or artificial intelligence satisfies the one or more criteria, the condition determination system 106 implements the machine learning algorithm or artificial intelligence to dynamically, and in real-time, process any digitized invoices associated with different users (such as user 112) to identify any conditions associated with these digitized invoices and for which claim adjudications are being sought. In an embodiment, the condition determination system 106 uses new claim adjudication data corresponding to newly processed invoices and any identified conditions to further retrain or otherwise update the machine learning algorithm or artificial intelligence. For instance, as the machine learning algorithm or artificial intelligence produces, in real-time or near real-time, outputs corresponding to different conditions that, in conjunction with associated invoices, may be processed in real-time or near real-time by the claims processing system 108 to provide different claim adjudications, the condition determination system 106 or other evaluator of the machine learning algorithm or artificial intelligence (e.g., a medical services provider, a third-party auditing service, etc.) may evaluate the output to determine whether the correct conditions were identified from the submitted invoices. This evaluation may result in additional annotated data points that may be used to retrain or otherwise update the machine learning algorithm or artificial intelligence in real-time or near real-time. For instance, if the machine learning algorithm or artificial intelligence identifies one or more conditions from a digitized invoice, and the resulting claim adjudication process results in a determination that different conditions are associated with the digitized invoice (e.g., the machine learning algorithm or artificial intelligence produced an erroneous output), the corresponding digital invoice may be annotated to indicate that the machine learning algorithm or artificial intelligence has erroneously selected one or more conditions for the particular digitized invoice. Additionally, in some instances, the corresponding digitized invoice may be annotated with the correct determination (e.g., the correct condition(s) that should have been identified from the digitized invoice, etc.). These annotated data points may be added to the training dataset, which may be used to dynamically retrain or otherwise update the machine learning algorithm or artificial intelligence using the process described above.

In an embodiment, once the condition determination system 106 has identified one or more conditions associated with the digitized invoice (e.g., one or more conditions for which treatments and/or procedures as indicated on the digitized invoice were performed, etc.), the condition determination system 106 can update the entry corresponding to the user 112 in the user accounts datastore 110 to associate the identified one or more conditions with the digitized invoice. This may allow for the claims adjudication service 102 to maintain a historical record of the conditions associated with the user 112 or other entity affiliated with the user 112 (e.g., a dependent, a pet, etc.), as well as any treatments and/or procedures performed to address the identified conditions. Additionally, this may allow for the claims adjudication service 102 to determine whether the provided treatments and/or procedures were performed to address a pre-existing condition or a new condition associated with the user 112 or other entity affiliated with the user 112. As described in greater detail herein, this updated data may further allow the claims adjudication service 102 to obtain statistical data that may be used to determine, for different identified conditions, the efficacy of prescribed treatments and/or procedures, the effectiveness of different providers, the expense associated with different treatments/procedures for particular conditions, and the like.

The condition determination system 106 may further provide the identified one or more conditions and the digitized invoice to a claims processing system 108 for automatic adjudication of the claims submitted by the user 112 with the invoice 114. The claims processing system 108 may be implemented on a computer system or other system (e.g., server, virtual machine instance, etc.) associated with the claims adjudication service 102. Alternatively, the claims processing system 108 may be implemented as an application or other executable process executed on one or more computer systems associated with the claims adjudication service 102. In an embodiment, the claims processing system 108 may automatically evaluate the digitized invoice, the identified one or more conditions, and the policy associated with the user 112 to adjudicate the one or more claims submitted by the user 112. For example, if the identified one or more conditions correspond to pre-existing conditions specified in the user entry in the user accounts datastore 110 that are not covered by the user's policy, the claims processing system 108 may automatically deny the user's claim. Alternatively, if the identified one or more conditions are covered by the user's policy, as defined in the user accounts datastore 110, the claims processing system 108 may automatically adjudicate the claim according to the parameters of the policy and provide a reimbursement to the user 112 for any upfront expenses incurred, as indicated in the invoice 114.

In an embodiment, the claims processing system 108 updates the user accounts datastore 110 to indicate any claims adjudications performed based on the invoices submitted by users and the corresponding conditions determined through the condition determination system 106. These updates may be used by the claims adjudication service 102 to generate statistical data corresponding to the identification of conditions for different users and/or entities affiliated with these different users (e.g., dependents, pets, etc.), as well as to generate statistical data corresponding to the adjudication of claims corresponding to these different conditions and users/other entities. This statistical data may be used, in some instances, to better define different insurance policies for users based on the demographics and other characteristics of these users or other entities that are to be insured.

In some instances, the claims processing system 108 may further revise the user accounts datastore 110 in the event that the condition determination system 106 failed to accurate identify one or more conditions from a received invoice 114. For example, if the claims processing system 108 rejects a claim based on a condition identified by the condition determination system 106 and an applicable policy associated with the user 112, the user 112 may be able to appeal this adjudication. Through this process, the user 112 may provide actual medical records associated with the user 112 or other entity affiliated with the user 112 (e.g., dependent, pet, etc.) for which the described treatments and/or procedures were performed. These actual medical records, in some instances, may explicitly define the one or more conditions for which the described treatments and/or procedures were performed. Thus, the actual medical records may serve as a ground truth for the identification of conditions from a provided invoice 114. As noted above, the condition determination system 106 may annotate any new data points corresponding to these received invoices (including received invoice 114) according to these ground truths. For example, if the machine learning algorithm or artificial intelligence implemented by the condition determination system 106 failed to accurately identify one or more conditions from the received invoice 114, the data point corresponding to this received invoice 114 may be annotated to indicate that the conditions identified by the machine learning algorithm or artificial intelligence were erroneous. Further, the data point corresponding to this received invoice 114 may be annotated to indicate the correct conditions that should have been identified by the machine learning algorithm or artificial intelligence and that were identified through the actual medical records. The annotated data point may be added to the training dataset for processing and retraining of the machine learning algorithm or artificial intelligence.

In an embodiment, as claim adjudications are performed by the claims processing system 108, the condition determination system 106 can, in real-time, update the keyword-based logic process and the machine learning algorithm or artificial intelligence implemented to automatically identify one or more conditions from received invoices to increase the accuracy of the process and of the machine learning algorithm/artificial intelligence. For example, if the condition determination system 106 identified, using the keyword-based logic process, a particular condition associated with a received invoice 114 (e.g., the keyword-based logic process identified the condition according to an appropriate confidence score) but the claims processing system 108 determines, based on an evaluation of the actual medical records corresponding to the received invoice 114, that a different condition was applicable (e.g., the identification of the condition by the condition determination system 106 was incorrect), the condition determination system 106 may use this feedback to dynamically update the keyword-based logic process such that, for similar invoices 114 and entities associated with these invoices, the confidence score for the identified condition is reduced. Further, for the actual condition associated with the invoice 114, the keyword-based logic process may be updated such that, for similar invoices and entities associated with these invoices, the likelihood of the actual condition being identified is increased (e.g., the confidence score associated with this condition may be assigned a higher value, etc.).

As another illustrative example, if the one or more identified conditions were determined using the aforementioned machine learning algorithm or artificial intelligence, and the claims processing system 108 determines that the one or more identified conditions do not correspond to the received invoice 114, the condition determination system 106 may evaluate the existing one or more vectors of similarity and clusters associated with the machine learning algorithm or artificial intelligence to modify one or more classification variables from a set of classification variables (e.g., the set of coefficients {α1, α2, α3, . . . αn}) associated with these one or more vectors of similarity to more accurately identify corresponding clusters and, hence, conditions for given invoices. In some instances, the modification of these one or more classification variables, along with the historical data corresponding to previously processed invoices and condition identifications, may be used to perform a re-clustering of the digitized invoices according to the one or more vectors. Accordingly, the machine learning algorithm or artificial intelligence may be dynamically updated to provide more accurate clustering or classification of digitized invoices as the claims associated with these invoices are adjudicated by the claims processing system 108.

It should be noted that the keyword-based logic process and the machine learning algorithm or artificial intelligence implemented by the condition determination system 106 may be dynamically, and continuously, updated in real-time or near real-time as invoices associated with different users and different medical events are received and as the claims associated with these invoices are adjudicated. Further, the keyword-based logic process and the machine learning algorithm or artificial intelligence may be dynamically, and continuously, updated in real-time or near real-time as feedback is received corresponding to the conditions assigned to received invoices. As noted above, if the claims processing system 108 obtains, during an adjudication appeals process, a set of actual medical records associated with a user or other entity affiliated with the user for a disputed adjudication of a claim associated with a received invoice, the set of actual medical records may be used to determine the actual condition associated with the received invoice. This determination of the actual condition for the received invoice may be used as feedback corresponding to the identification of one or more conditions for the received invoice performed by the condition determination system 106 through the keyword-based logic process or the machine learning algorithm/artificial intelligence. Thus, as invoices are continuously received for myriad users and medical events, and as corresponding claim adjudications are performed, the condition determination system 106 may dynamically, and in real-time, continuously update the keyword-based logic process and the machine learning algorithm or artificial intelligence to improve their accuracy in automatically identifying conditions associated with these invoices.

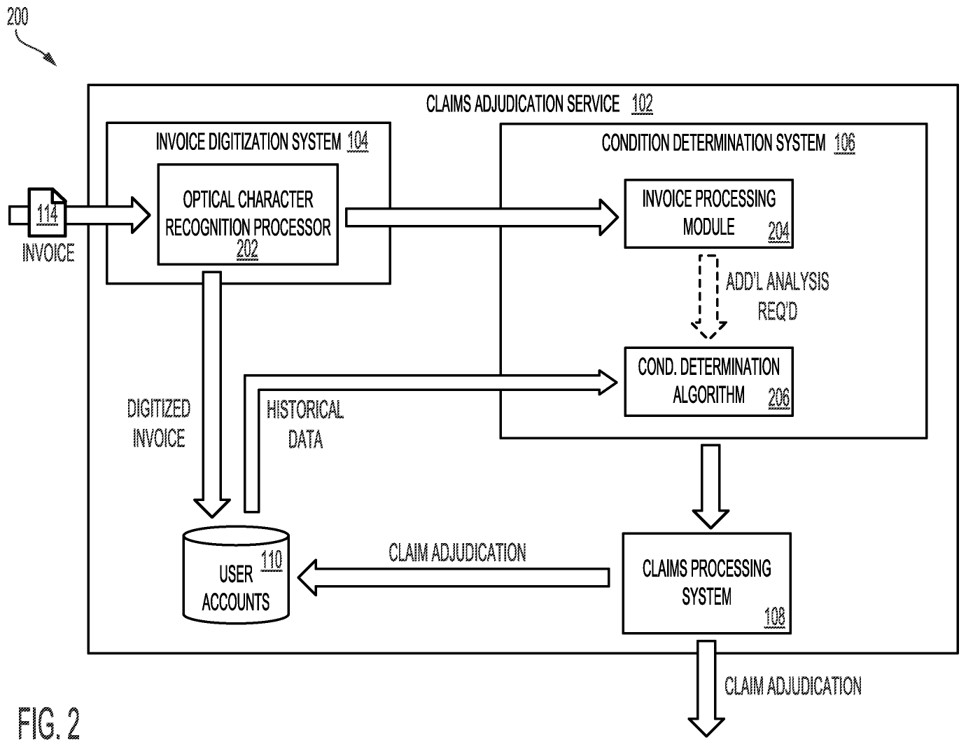

FIG. 2 shows an illustrative example of an environment 200 in which parameters corresponding to an obtained invoice 114 are dynamically and automatically processed through an invoice processing module 204 and/or condition determination algorithm 206 to identify any relevant conditions for claims adjudication associated with the invoice 114 in accordance with at least one embodiment. In the environment 200, the claims adjudication service 102, through an invoice digitization system 104, may process an incoming invoice 114 to generate a digitized version of the invoice and to identify any keywords or other parameters associated with the invoice 114 that may be used to determine one or more conditions for which the specified treatments and/or procedures indicated in the invoice 114 were performed. In an embodiment, the invoice digitization system 104 implements an optical character recognition (OCR) processor 202 that may be configured to generate the digitized version of the invoice 114. The OCR processor 202 may be implemented on a computer system or other system (e.g., server, virtual machine instance, etc.) associated with the invoice digitization system 104. Alternatively, the OCR processor 202 may be implemented as an application or other executable process executed on one or more computer systems associated with the invoice digitization system 104.

The OCR processor 202 may automatically scan invoice 114 to automatically, and in real-time, identify any text include in the invoice 114 and to generate a digitized version of the invoice 114. The digitization of the invoice 114 may be performed by the OCR processor 202 using an OCR process, whereby the invoice 114 is digitized into a machine-readable format to allow for discernment of textual elements from the invoice 114. As noted above, a user may submit a physical or electronic version of the invoice 114 to the invoice digitization system 104 to request adjudication of one or more claims submitted for reimbursement of upfront expenses incurred by the user for the line items in the invoice 114. The OCR processor 202 may perform the aforementioned OCR process on the physical or electronic version of the invoice 114 to identify the text included in the invoice 114 and to generate the searchable, digitized version of the invoice 114.

In an embodiment, the OCR processor 202 further includes one or more NLP algorithms that are dynamically trained in real-time to process digitized versions of received invoices to extract elements useful in identifying any underlying conditions for which the treatments and/or procedures indicated in these received invoices were performed. These one or more NLP algorithms may automatically process digitized invoices in real-time as these digitized invoices are generated from received invoices to identify any relevant terms corresponding to treatments and/or procedures performed. As noted above, these one or more NLP algorithms may be dynamically trained to extract any terms corresponding to drug entities from invoice line items. Further, the one or more NLP algorithms may be dynamically trained to extract drug, treatment, and symptom entities from any FNOL diagnosis entries in digitized invoices. The OCR processor 202 may store the digitized version of the invoice 114 within an entry corresponding to the user that submitted the invoice 114 in the user accounts datastore 110. Further, the OCR processor 202 may transmit the digitized version of the invoice 114 and the extracted terms to an invoice processing module 204 implemented by the condition determination system 106.

In an embodiment, the invoice processing module 204 processed the digitized version of the invoice 114 and the extracted terms through a data structure to determine whether these extracted terms correspond to one or more known conditions. As noted above, the data structure may include a mapping of particular terms or term combinations to known conditions. For example, a combination of terms corresponding to different pharmaceutical entities may correspond to a particular condition for which these different pharmaceutical entities are known to be used to address the symptoms associated with the particular condition. The data structure may be defined through historical analysis of past treatments and procedures for different conditions such that certain treatments and procedures performed for certain conditions may be connected and thus mapped to one another. In some instances, the data structure may be further defined based on medical or veterinary literature or journals, through which recommended treatments and/or procedures for different conditions may be indicated.

In an embodiment, in order for a condition to be definitively identified from this data structure, the invoice processing module 204 can be required to correlate all extracted terms from the digitized version of the invoice 114 to the condition. For example, if the invoice processing module 204 determines that all of the extracted terms from the invoice 114 are not mapped to a particular condition or set of conditions within the data structure, the invoice processing module 204 may determine that a condition could not be definitively identified for the invoice 114 using the data structure. However, if all of the extracted terms from the invoice 114 are mapped to a particular condition or set of conditions within the data structure, the invoice processing module 204 may associate this particular condition or set of conditions with the invoice 114 and may accordingly transmit the digitized version of the invoice 114 and the identified condition or set of conditions to the claims processing system 108 for adjudication of the submitted claims according to the identified condition or set of conditions and any applicable insurance policies associated with the user or entity affiliated with the user for which the indicated treatments and/or procedures were performed.

In an embodiment, the invoice processing module 204 further implements a keyword-based logic process that can be used to perform further evaluation of a digitized version of an invoice should the invoice processing module 204 be unable to identify one or more conditions from the invoice using the aforementioned data structure. The keyword-based logic process may be implemented based on one or more automated tagging techniques, such as NER. Further, the keyword-based logic process may automatically assign a confidence score to each tag applied to the extracted terms associated with the digitized version of the invoice 114. This confidence score may denote a confidence level in the accuracy of the tag identification (e.g., identification of a particular condition for the invoice 114). For instance, a higher confidence score for a given condition tag assigned to one or more extracted terms from the invoice 114 may denote a higher likelihood (e.g., confidence) that the condition associated with this condition tag is applicable to the invoice 114.

As noted above, the identification of one or more conditions associated with a received invoice, such as invoice 114, through NER tagging may be contingent on corresponding condition tags having confidence scores greater than a minimum threshold value. For instance, if a particular condition tag assigned to one or more extracted terms from the invoice 114 has a corresponding confidence score below the pre-defined minimum threshold value, the invoice processing module 204 may automatically disregard this condition tag for the invoice 114. Thus, the condition associated with the condition tag may not be considered as being applicable to the invoice 114. However, if an applied condition tag has a corresponding confidence score that satisfies this minimum threshold value, the invoice processing module 204 may automatically assign the condition corresponding to the applied condition tag to the invoice 114.

The keyword-based logic process implemented by the invoice processing module 204 may be dynamically tuned over time as claims corresponding to different invoices are adjudicated over time. For instance, as described in greater detail herein, as claims corresponding to received invoices are adjudicated, determinations as to the accuracy of the keyword-based logic process in assigning conditions to extracted terms may be evaluated. For example, if this process assigned a high confidence to a particular condition tag for extracted terms within an invoice, and it is determined that the corresponding condition was not applicable to the invoice (such as through evaluation of actual medical records, auditing, etc.), the keyword-based logic process may be tuned such that for similar invoices and extracted terms, the likelihood of the condition tag being applied is reduced (e.g., the confidence score assigned to the condition tag for similar extracted terms is reduced). Additionally, the process may be further tuned such that for similar invoices and extracted terms, the likelihood of a condition tag corresponding to the actual condition being applied to these similar invoices and terms is increased.

As noted above, in some instances, the keyword-based logic process may be unable to assign a condition to a received invoice. For example, in some instances, the confidence scores corresponding to different condition tags assigned to a received invoice may below the pre-defined minimum threshold value. This may denote a lack of confidence in the identification of any conditions associated with the received invoice. In such situations, the invoice processing module 204 may process the digitized version of the invoice 114 through a condition determination algorithm 206 to identify and assign one or more conditions to the digitized version of the invoice 114. The condition determination algorithm 206 may be a clustering or classification algorithm that is dynamically trained, in real-time, to classify the digitized invoices and corresponding keywords according to a set of different classifications (e.g., conditions). The condition determination algorithm 206 may be dynamically trained using a dataset of sample digitized invoices and corresponding extracted terms (e.g., historical invoices and terms, hypothetical or artificial invoices and terms, etc.) from the user accounts datastore 110. For instance, the condition determination algorithm 206 may be dynamically trained in real-time by classifying the digitized invoices and corresponding terms extracted by the OCR processor 202 according to one or more vectors of similarity between the digitized invoices/terms and other clusters of digitized invoices corresponding to different conditions associated with the condition determination system 106. Thus, the condition determination algorithm 206 may perform such clustering and obtain partial matches among other clusters of digitized invoices according to these one or more vectors to identify a particular cluster. From this cluster, the condition determination algorithm 206 may identify and assign the one or more conditions to the digitized version of the invoice.

As noted above, the different vectors associated with the condition determination algorithm 206 may correspond to input data fields identified from digitized versions of invoices by the OCR processor 202. These different vectors, thus, may correspond to different input variables from the digitized versions of the invoices. These input variables may include, but are not limited to, item descriptions from the invoices (e.g., pharmaceutical entities, etc.), pet species, pet breeds, pet gender, pet age, climate zones (based on identified zip codes or other location data), rurality (based on identified zip codes or other location data), FNOL condition codes, FNOL diagnoses, previous claims, pre-existing conditions prior to insurance enrollment, and the like. The different clusters or classifications that may be associated with these different vectors may correspond to different condition codes or types for which the claims adjudication service 102 may evaluate any received claims for adjudication. Thus, the different extracted terms from the invoice 114 may be used as corresponding input values for the different vectors in order to identify a proximate cluster. This proximate cluster may denote a particular condition code or type that may be used to assign one or more conditions to the invoice 114.

In an embodiment, the condition determination algorithm 206 is dynamically trained through an iterative process, whereby an initial iteration of the condition determination algorithm 206 may be generated by initializing a set of coefficients {α1, α2, α3, . . . αn} randomly according to a Gaussian distribution with low variance centered around zero. Using this initial iteration of the condition determination algorithm 206, the condition determination system 106 may process the dataset of sample digitized invoices and corresponding extracted terms (e.g., historical invoices and terms, hypothetical or artificial invoices and terms, etc.) from the user accounts datastore 110 to generate an initial output (e.g., identified conditions corresponding to each data point or sample digitized invoice). The condition determination system 106 may compare the output generated using the initial iteration of the condition determination algorithm 206 to the sample conditions defined in the dataset for each of the data points (e.g., sample digitized invoices and corresponding keywords) to identify any inaccuracies or other errors.

If the condition determination system 106 determines that the output of the condition determination algorithm 206 does not satisfy one or more criteria related to the accurate identification of conditions from digitized invoices, the condition determination system 106 may iteratively update one or more coefficients of the set of coefficients to generate new iterations of the condition determination algorithm 206. A new iteration of the condition determination algorithm 206 may be used to process the aforementioned training dataset, as well as any additional data points or other datasets provided by the claims adjudication service 102 or other entity (e.g., a medical services provider, etc.) to generate a new output for each data point in the training dataset. In some instances, the condition determination system 106 may use an optimization algorithm to iteratively update the one or more coefficients of the set of coefficients associated with the condition determination algorithm 206. For instance, the condition determination system 106 may usc gradient descent to update the logistic coefficients of the condition determination algorithm 206 to generate new cutoff values that may be used to classify the data points of the previously evaluated dataset and of any new data points obtained by the condition determination system 106. The condition determination system 106 may use this new iteration of the condition determination algorithm 206 to process the available data points and generate a new output. The condition determination system 106 may evaluate this new output to determine whether the output of the new iteration of the condition determination algorithm 206 satisfies the one or more criteria. This process of updating the set of coefficients associated with the condition determination algorithm 206 according to the one or more criteria may be performed iteratively until an iteration of the condition determination algorithm 206 is produced that satisfies the one or more criteria.

In an embodiment, once the condition determination system 106 (either through the invoice processing module 204 or the condition determination algorithm 206) has assigned one or more conditions to the invoice 114, the condition determination system 106 may update an entry in the user accounts datastore 110 corresponding to the user associated with the applicable policy to incorporate the one or more conditions identified for the invoice 114. The entry in the user accounts datastore 110, as noted above, may include a historical record of received invoices, corresponding claim adjudications, diagnosed conditions, treatments/procedures performed to address the diagnosed conditions, policy information, demographic information corresponding to the insured entity, pre-existing conditions associated with the insured entity, and the like. This entry may allow the claims processing system 108 to determine whether the treatments and/or procedures indicated on the invoice 114 were performed to address a pre-existing condition or a new condition associated with the insured entity. Further, this historical record associated with the insured entity may be used in conjunction with other historical records corresponding to other insured entities to aggregate statistical data that may be used to determine the efficacy of different treatments and/or procedures for different conditions. Further, this aggregated statistical data may be used to determine the effectiveness of different providers in different geographic areas in addressing any diagnosed conditions. This may allow the claim adjudication service 102 to provide additional metrics that may be used to define new or alternative insurance policies and applicable terms according to different demographics, pre-existing conditions, and the like.

In addition to updating the entry corresponding to the insured entity (or user that obtained the policy for the insured entity) in the user accounts datastore 110 to incorporate the digitized version of the invoice 114 and annotations corresponding to the conditions identified from the invoice 114, the condition determination system 106 may transmit the digitized version of the invoice 114 and these annotations to the claims processing system 108. In response to obtaining the digitized version of the invoice 114 and the annotations corresponding to the identified conditions, the claims processing system 108 may process the provided claims to determine whether reimbursement for the expenses incurred for the treatment and/or procedures specified in the invoice 114 may be provided. For instance, as noted above, the claims processing system 108 may automatically evaluate the digitized version of the invoice 114, the assigned one or more conditions, and the policy associated with the insured entity to adjudicate the one or more claims associated with the invoice 114. Returning to an earlier example, if the identified one or more conditions correspond to pre-existing conditions that are not covered by an applicable policy (as specified in the entry in the user accounts datastore 110 corresponding to the insured entity), the claims processing system 108 may automatically deny the claim associated with the invoice 114. Alternatively, if the identified one or more conditions are covered by the applicable policy, as defined in the entry in the user accounts datastore 110, the claims processing system 108 may automatically adjudicate the claim according to the parameters of the policy and provide a reimbursement for any upfront expenses incurred, as indicated in the invoice 114.

As the claims processing system 108 automatically processes and adjudicates any claims associated with received invoices (such as invoice 114) according to any identified conditions and policy parameters, the claims processing system 108 may update the user accounts datastore 110 to indicate these adjudications. As noted above, entries in the user accounts datastore 110 may include historical records of received invoices, corresponding claim adjudications, diagnosed conditions, treatments/procedures performed to address the diagnosed conditions, policy information, demographic information corresponding to the insured entity, pre-existing conditions associated with the insured entity, and the like. Thus, the updates performed by the claims processing system 108 may be further used to continue aggregation of statistical data corresponding to the identification of conditions for different insured entities and to the adjudication of claims associated with these identified conditions.

In some instances, the claims adjudication service 102 may allow users to appeal a claim adjudication made by the claims processing system 108 should users disagree with the claim adjudication. For example, if the claims processing system 108 rejects a claim corresponding to expenses incurred for a particular treatment or procedure because the particular treatment or procedure was deemed to be associated with a pre-existing condition (as determined by the condition determination system 106), but a user disagrees with the identification of the pre-existing condition, the user may initiate an appeals process for further review of their claim. Through this appeals process, the user may provide medical records, additional documentation from the provider of the treatment or procedure, and the like to dispute the identification of the pre-existing condition. Based on this appeals process, it may be determined that the condition determination system 106 has assigned the incorrect condition to the invoice 114 previously submitted. In such instances, claims processing system 108 may annotate the entry correspond to the insured entity to indicate that the condition assigned to the invoice 114 was incorrect. Further, the claims processing system 108 may indicate, for the invoice 114, the correct condition diagnosis and the corresponding adjudication resulting from the correct condition diagnosis.

In an embodiment, if a correction is made to a particular invoice 114 to indicate the actual condition for which the indicated treatments and/or procedures were provided, the condition determination system 106 can use this correction to update the keyword-based logic process and the condition determination algorithm 206 to more accurately identify the conditions associated with received invoices. Returning to an earlier example, if the invoice processing module 204 identified, using the aforementioned keyword-based logic process, a particular condition associated with a received invoice 114 that was later determined to be erroneous (based on an evaluation of the actual medical records corresponding to the received invoice, etc.), the condition determination system 106 may use this feedback to dynamically update the keyword-based logic process such that, for similar invoices and insured entities associated with these invoices, the confidence score for the identified condition may be reduced (e.g., the identified condition is less likely to satisfy the minimum threshold score for assignment). Additionally, the keyword-based logic process may be updated such that, for the actual condition associated with the invoice, the keyword-based logic may assign a higher confidence score to the actual condition for similar invoices and insured entities associated with these invoices. This may increase the likelihood of the actual condition being assigned to these invoices (e.g., the confidence score associated with this condition may be assigned a higher value that exceeds the minimum threshold value, etc.).

Similar to the updating of the keyword-based logic process, the condition determination system 106 may update, in real-time, the condition determination algorithm 206 to more accurately identify conditions from invoices as these invoices are received and processed. For instance, if the condition determination algorithm 206 classified an invoice as corresponding to a particular condition, and the claims processing system 108 determines that this classification was erroneous (e.g., the invoice corresponds to a different condition, as determined through an appeals process or other auditing of invoice classifications, etc.), the condition determination system 106 may evaluate the existing one or more vectors of similarity and clusters associated with the condition determination algorithm 206 to modify one or more variables corresponding to these vectors in order to increase the likelihood of similar invoices for similar insured entities being classified according to the correct condition. As noted above, in some instances, the modification of these one or more variables, along with the historical data corresponding to previously processed invoices and condition assignments, may be used to perform a re-clustering of these historical invoices according to the one or more updated vectors. Accordingly, the condition determination algorithm 206 may be dynamically updated to provide more accurate clustering or classification of received invoices as the claims associated with these invoices are adjudicated by the claims processing system 108.

As noted above, the condition determination algorithm 206 may be dynamically trained, in real-time or near real-time, through an iterative process whereby the condition determination algorithm 206 may be continually trained and evaluated until an iteration of the condition determination algorithm 206 is generated that satisfies one or more criteria. In an embodiment, if the condition determination algorithm 206 incorrectly classifies a received invoice 114 as corresponding to a particular condition (e.g., the invoice corresponds to a different condition, as determined through an appeals process or other auditing of invoice classifications, etc.), the condition determination system 106 may update the training dataset to annotate a new data point corresponding to the invoice 114 to indicate that the condition identified by the condition determination algorithm 206 was erroneous and to indicate the actual condition(s) associated with the invoice 114, as determined through the appeals process.

The condition determination system 106 may process the updated training dataset through the condition determination algorithm 206 to determine whether the condition determination algorithm 206 continues to satisfy the one or more criteria. If the condition determination system 106 determines that, based on the updated training dataset, that the condition determination algorithm 206 no longer satisfies the one or more criteria, the condition determination system 106 may iteratively update one or more coefficients of the set of coefficients of the condition determination algorithm 206 to generate new iterations of the condition determination algorithm 206. Each new iteration of the condition determination algorithm 206 may be evaluated by processing the updated training dataset through the new iteration of the condition determination algorithm 206 and determining whether the resulting output satisfied the one or more process. This iterative process may continue until a new iteration of the condition determination algorithm 206 is obtained that satisfied the one or more criteria.

As noted above, the keyword-based logic process and the condition determination algorithm 206 may be continuously updated in real-time as new invoices and claims are received and adjudicated by the claims adjudication service 102. For instance, the keyword-based logic process and the condition determination algorithm 206 may simultaneously process different invoices and claims associated with different insured entities as these invoices and claims are received to assign different conditions to these invoices. Further, as the claims processing system 108 adjudicates the claims corresponding to these invoices according to the assigned conditions (including any corrections made during the appeals process for contested adjudications), the condition determination system 106 may, in real-time, update the keyword-based logic process and the condition determination algorithm 206 to improve the classifications made to these invoices according to the identified conditions. This continuous and iterative process may allow for the keyword-based logic process and the condition determination algorithm 206 to constantly process any invoices as these invoices are received and accurately assign conditions to these invoices, which may then be used to adjudicate the claims associated with these invoices.

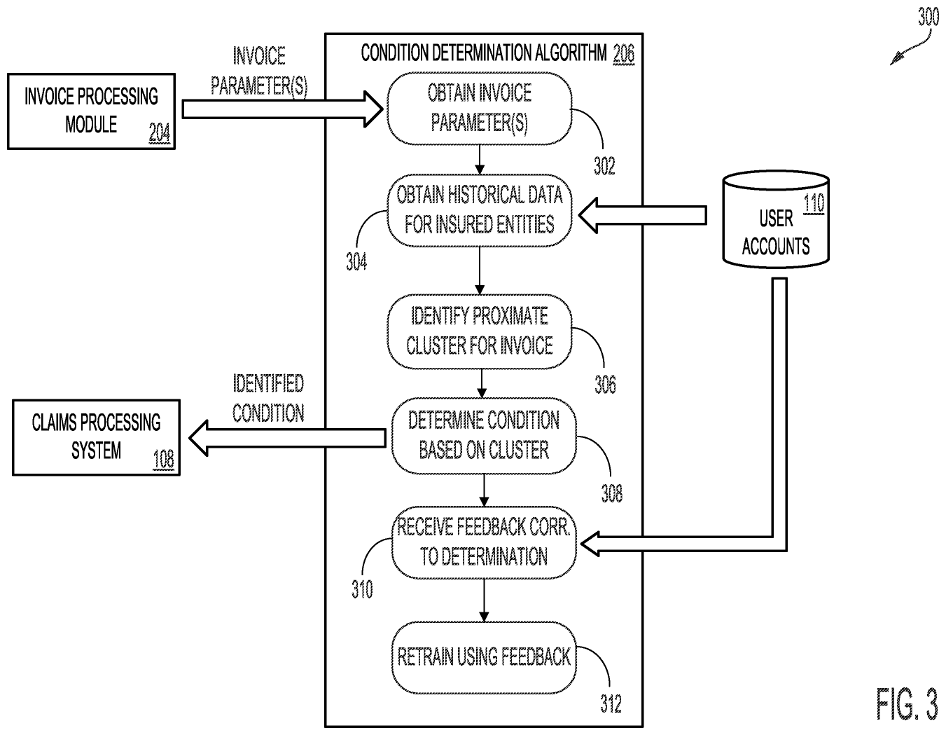

FIG. 3 shows an illustrative example of an environment 300 in which a condition determination algorithm 206 is dynamically trained in real-time to process invoice parameters to determine one or more conditions corresponding to received invoices for adjudication of claims associated with the received invoices in accordance with at least one embodiment. In the environment 300, the condition determination algorithm 206, at step 302, may obtain a set of invoice parameters corresponding to a particular invoice originally processed by the invoice processing module 204. As noted above, the invoice processing module 204 may initially process an incoming invoice using a data structure that defines a mapping of extracted terms with known conditions associated with these terms. If the invoice processing module 204 determines that all of the extracted terms from the invoice are not mapped to a particular condition or set of conditions within the data structure, the invoice processing module 204 may determine that a condition could not be definitively identified for the invoice using the data structure. Accordingly, the invoice processing module 204 may process the invoice through a keyword-based logic process to determine whether one or more conditions may be assigned to the invoice. This determination may be performed through NER tagging and corresponding confidence score, whereby any tags (e.g., conditions) having a confidence greater than a minimum threshold value may be automatically assigned to the invoice. In the environment 300, the invoice processing module 204 may provide the set of invoice parameters corresponding to the invoice (e.g., any extracted terms, identifying information corresponding to the insured entity, etc.) to the condition determination algorithm 206 as a result of the invoice processing module 204 being unable to assign one or more conditions to the invoice using the aforementioned data structure and keyword-based logic process.

At step 304, the condition determination algorithm 206 may obtain historical data corresponding to different insured entities and previously adjudicated claims associated with these insured entities. As noted above, the condition determination algorithm 206 may be a clustering or classification algorithm that is dynamically trained, in real-time, to classify digitized versions of received invoices and corresponding keywords according to a set of different classifications (e.g., conditions). The condition determine algorithm 206 may be dynamically trained using a dataset of sample digitized versions of invoices and corresponding extracted terms (e.g., historical invoices and terms, hypothetical or artificial invoices and terms, etc.) from the user accounts datastore 110. For instance, the condition determination algorithm 206 may be dynamically trained in real-time by classifying the digitized versions of the invoices and corresponding terms extracted from these invoices according to one or more vectors of similarity between the invoices/extracted terms and clusters of invoices corresponding to different conditions associated with the condition determination system 106. Thus, the obtained historical data may be used to define the different set of clusters that may be used to classify the received invoice in order to identify the one or more conditions that may be associated with the invoice.

At step 306, the condition determination algorithm 206 may assign values to the extracted terms and other parameters from the obtained invoice according to the one or more vectors. Through these one or more vectors, the condition determination algorithm 206 may identify a proximate cluster for the received invoice. For instance, the condition determination algorithm 206 may obtain partial matches among the clusters of invoices according to these one or more vectors to identify a particular cluster that the invoice may be most closely associated with.

As noted above, each cluster maintained by the condition determination algorithm 206 may correspond to different sets of conditions that may be associated with the different invoices included within the cluster. For instance, the different clusters or classifications that may be associated with the aforementioned vectors may correspond to different condition codes or types for which the claims adjudication service may evaluate any received claims for adjudication. Thus, at step 308, from the identified proximate cluster, the condition determination algorithm 206 may determine a particular condition code or type that may be used to assign one or more conditions to the invoice. Further, the condition determination algorithm 206 may transmit the digitized version of the invoice and the annotations corresponding to the conditions identified through clustering of the extracted terms and parameters associated with the invoice to the claims processing system 108. In response to obtaining the digitized version of the invoice and these annotations, the claims processing system 108 may process the provided claims to determine whether reimbursement for the expenses incurred for the treatment and/or procedures specified in the invoice may be provided.

At step 310, the condition determination algorithm 206 may receive feedback corresponding to the set of conditions assigned to the invoice by the condition determination algorithm 206. For instance, as the claims processing system 108 automatically processes and adjudicates any claims associated with received invoices according to any identified conditions and policy parameters, the claims processing system 108 may update the user accounts datastore 110 to indicate these adjudications. These updates performed by the claims processing system 108 may be used to continue aggregation of statistical data corresponding to the identification of conditions for different insured entities and to the adjudication of claims associated with these identified conditions. In some instances, the claims processing system 108 may further update the user accounts datastore 110 in the event that corrections are made to a previous adjudication to a claim as a result of erroneous conditions being identified for a given invoice. As noted above, the claims adjudication service may allow users to appeal a claim adjudication made by the claims processing system 108 should these users disagree with their claim adjudications. This appeals process may allow these users to introduce medical records, additional documentation from medical providers, and the like to dispute the prior condition assignments to their invoices. If there are any successful appeals, the claims processing system 108 may update the user accounts datastore 110 to annotate the prior classification of the subject invoices to indicate the correct conditions associated with these subject invoices and to indicate the error made by the condition determination algorithm 206 in identifying the conditions for these invoices. This may serve as feedback corresponding to the performance of the condition determination algorithm 206 in assigning conditions to different invoices.

At step 312, the condition determination algorithm 206 may be retrained using the feedback obtained from the user accounts datastore 110. For instance, as this feedback is obtained from the user accounts datastore 110, the condition determination algorithm 206 may be retrained to more accurately identify conditions associated with different invoices as these invoices are received and processed. For instance, if the condition determination algorithm 206 classified an invoice as corresponding to a particular condition, and the claims processing system 108 determines that this classification was erroneous (e.g., the invoice corresponds to a different condition, as determined through an appeals process or other auditing of invoice classifications, etc.), the existing one or more vectors of similarity and clusters associated with the condition determination algorithm 206 may be evaluated in order to determine the modifications to be made to the one or more variables corresponding to these vectors in order to increase the likelihood of similar invoices for similar insured entities being classified according to the correct condition. As noted above, in some instances, the modification of these one or more variables, along with the historical data corresponding to previously processed invoices and condition assignments, may be used to perform a re-clustering of these historical invoices according to the one or more updated vectors. Accordingly, the condition determination algorithm 206 may be dynamically updated to provide more accurate clustering or classification of received invoices as the claims associated with these invoices are adjudicated by the claims processing system 108.

In an embodiment, the condition determination algorithm 206, at step 312, is re-evaluated to determine, based on the obtained feedback, whether the condition determination algorithm 206 satisfies a set of criteria. As noted above, this set of criteria may include a threshold for the accuracy of the condition determination algorithm 206 for identifying different conditions from provided invoices. Using the feedback obtained from the user accounts datastore 110, the training dataset used to train and evaluate the condition determination algorithm 206 may be dynamically updated to indicate, for the different invoices processed through the condition determination algorithm 206, whether the indicated conditions were correctly identified and, if not, the actual conditions that are associated with the different invoices and that should have been identified by the condition determination algorithm 206 (e.g., the ground truth for condition identification). These annotations made to the received invoice parameters for each invoice may be added to the training dataset as new data points that may be used to evaluate the condition determination algorithm 206.

If the condition determination algorithm 206, based on the updated training dataset, continues to satisfy the set of criteria, the condition determination algorithm 206 may continue to process incoming invoice parameters associated with newly received invoices without need for retraining. Alternatively, if the condition determination algorithm 206 no longer satisfies the set of criteria, the condition determination algorithm 206 may be iteratively updated until a new iteration of the condition determination algorithm 206 is produced that satisfies the set of criteria. For instance, as noted above, the condition determination system that implements the condition determination algorithm 206 may iteratively update one or more coefficients of the set of coefficients of the condition determination algorithm 206 to generate a new iteration of the condition determination algorithm 206. The new iteration of the condition determination algorithm 206 may process the updated training dataset to generate new condition determinations that may be evaluated according to the set of criteria to determine whether this new iteration of the condition determination algorithm 206 satisfies this set of criteria. If the new iteration of the condition determination algorithm 206 still fails to satisfy the set of criteria, the condition determination system may continue to iteratively update the condition determination algorithm 206 until an iteration of the condition determination algorithm 206 is generated that satisfies the set of criteria. Once a new iteration of the condition determination algorithm 206 is identified that satisfies the set of criteria, this new iteration of the condition determination algorithm 206 may be deployed to process, in real-time, new invoice parameters corresponding to newly received invoices to identify any corresponding conditions.

It should be noted that process illustrated in FIG. 3 and performed by the condition determination algorithm 206 (e.g., steps 302-312) may be performed concurrently and in real-time or near real-time for any number of invoices as these invoices are received. For instance, as new invoice parameters are received for new and different invoices, the condition determination algorithm 206 may automatically identify, in real-time or near real-time, different conditions associated with these new and different invoices. Further, as new feedback is received with regard to different conditions identified by the condition determination algorithm 206 for different invoices, the condition determination system may dynamically update, in real-time or near real-time, the training dataset used to train the condition determination algorithm 206, as described above.

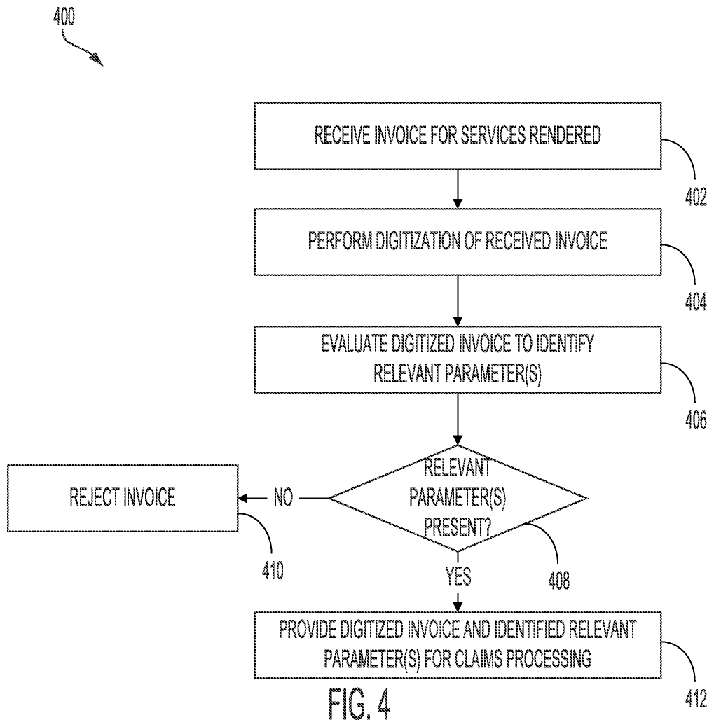

FIG. 4 shows an illustrative example of a process 400 for digitizing a received invoice and identifying relevant parameters from the digitized invoice for condition identification and claim adjudication in accordance with at least one embodiment. The process 400 may be performed by the invoice digitization system 104 described above in connection with FIGS. 1 and 2. Further, certain operations associated with the process 400 may be performed by the OCR processor 202 described above in connection with FIG. 2.

At step 402, the invoice digitization system 104 may receive an invoice for services rendered to an insured entity. For instance, a user associated with the claims adjudication service may send, to the claims adjudication service, a physical or electronic copy of an invoice corresponding to different treatments and/or procedures performed for the benefit of the user or other insured entity that may be associated with the user (e.g., a dependent, a pet, etc.). As noted above, the invoice may indicate any medications provided by a provider at the time of the performance of the treatments and/or procedures. In some instances, the invoice may additionally, or alternatively, indicate any prescriptions for medications that are to be applied for the treatment of one or more conditions. For example, the invoice may include one or more FNOL condition codes, FNOL diagnoses, and the like. The invoice, in some examples, may further include additional notes or documentation corresponding to any medication or treatment plans that are to be followed for any underlying conditions. The invoice can further include identifying information associated with the user or other insured entity for which the invoice was created. This identifying information may include the user's name, date of birth, address, contact information, and the like. If the treatments and/or procedures were performed for the benefit of an insured entity other than the user, the invoice may indicate the insured entity's name, date of birth, address, contact information (if applicable), pet species, pet breed, pet gender, pet age, and the like. In some examples, the invoice may further include identifying information associated with the provider of the treatments and/or procedures performed.

At step 404, the invoice digitization system, through the aforementioned OCR processor, may perform a digitization process for the received invoice to generate a digitized and machine-readable version of the invoice. The OCR processor, in an embodiment, automatically scans the received invoice in real-time to identify any text included in the invoice. For instance, if the user submitted a physical copy of an invoice to the invoice digitization system, the OCR processor may perform an initial scan of the invoice to generate an electronic version of the invoice. This electronic version of the invoice may initially only include a digital image of the invoice, which may not searchable or editable. Accordingly, the OCR processor may process the electronic version of the invoice to identify the text included in the electronic version of the invoice and to generate the searchable digitized version of the invoice. Similarly, if the user submitted an electronic version of the invoice (such as through an online claims submission process provided by the claims adjudication service, etc.), the OCR processor may process the electronic version of the invoice to identify the text included in the electronic version of the invoice and to generate a searchable, digitized version of the invoice.

At step 406, the OCR processor implemented by the invoice digitization system may evaluate the digitized version of the invoice to identify any relevant parameters that may be used to identify any conditions associated with the invoice. The OCR processor may implement one or more NLP algorithms that are dynamically trained, in real-time, to process digitized versions of received invoices to extract any parameters that may be useful in identifying any underlying conditions for which the treatments and/or procedures indicated in these received invoices were performed. Using the one or more NLP algorithms, the OCR processor may automatically process the digitized version of the invoice to identify any relevant terms corresponding to treatments and/or procedures performed. As noted above, the one or more NLP algorithms may be dynamically trained to extract any terms corresponding to drug entities from invoice line items. Further, the one or more NLP algorithms may be dynamically trained to extract drug, treatment, and symptom entities from any FNOL diagnosis entries in digitized invoices.

At step 408, the OCR processor may determine whether any relevant parameters are present within the digitized version of the invoice. For instance, the OCR processor may evaluate the output of the one or more NLP algorithms to determine whether any of the extracted text has been classified according to any of the categories required for identification of underlying conditions for which the indicated treatments and/or conditions were performed and for adjudication of the submitted claims according to these conditions. For example, the OCR processor may evaluate the output of the one or more NLP algorithms to determine whether these one or more NLP algorithms have extracted parameters, from the invoice, corresponding to item descriptions (e.g., pharmaceutical entities, etc.), pet species, pet breeds, pet gender, pet age, climate zones (based on identified zip codes or other location data), rurality (based on identified zip codes or other location data), FNOL condition codes, FNOL diagnoses, previous claims, pre-existing conditions prior to insurance enrollment, and the like. If the OCR processor is unable to identify any relevant parameters from the received invoice, the OCR processor may reject the invoice at step 410.

If the OCR processor is able to identify any relevant parameters from the digitized version of the invoice, the OCR processor, at step 412, may provide the digitized version of the invoice and the identified relevant parameters for further processing of the submitted claims. The OCR processor may store the digitized version of the invoice within an entry corresponding to the user that submitted the invoice in the user accounts datastore. Further, the OCR processor may transmit the digitized version of the invoice and the extracted terms to the condition determination system. As noted above, the condition determination system may process digitized versions of invoices and corresponding relevant parameters in real-time and as these digitized versions of invoices are received to automatically the one or more conditions subject to the treatments and/or procedures indicated in these digitized versions of the received invoices.

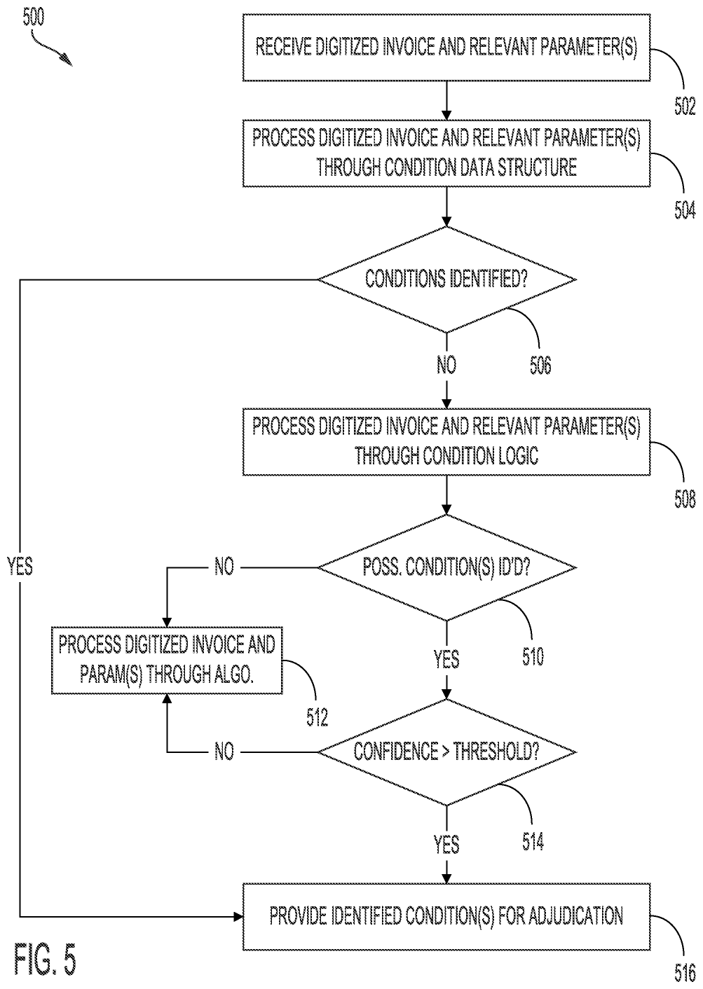

FIG. 5 shows an illustrative example of a process 500 for analyzing a digitized invoice and corresponding parameters to identify one or more conditions according to applicable confidence thresholds for claim adjudication in accordance with at least one embodiment. The process 500 may be performed by the condition determination system 106 described above in connection with FIGS. 1-2. As noted above, the condition determination system may implement an invoice processing module 204 (as described in FIGS. 2-3) to automatically process received invoices and corresponding parameters to dynamically identify the underlying conditions associated with these invoices. Thus, certain operations of the process 500 described herein may be performed by the invoice processing module.

At step 502, the condition determination system receives a digitized version of an invoice and the relevant parameters corresponding to this invoice. As noted above, an OCR processor implemented by the invoice digitization system may automatically, and in real-time, process an incoming invoice to generate a machine-readable and digitized version of the invoice. Through one or more NLP algorithms, the OCR processor may extract a set of relevant parameters associated with the digitized version of the invoice. This set of relevant parameters may correspond to item descriptions (e.g., pharmaceutical entities, etc.), pet species, pet breeds, pet gender, pet age, climate zones (based on identified zip codes or other location data), rurality (based on identified zip codes or other location data), FNOL condition codes, FNOL diagnoses, previous claims, pre-existing conditions prior to insurance enrollment, and the like.

At step 504, the condition determination system may process the digitized version of the invoice and the corresponding relevant parameters through a condition-based data structure to determine whether these relevant parameters are directly associated with one or more underlying conditions. As noted above, the data structure may include a mapping of particular terms or term combinations to known underlying conditions. For example, a combination of terms corresponding to different pharmaceutical entities may correspond to a particular condition for which these different pharmaceutical entities are known to be used to address the symptoms associated with the particular condition. The data structure may be defined through historical analyses of past treatments and procedures for different conditions such that certain treatments and procedures performed for certain conditions may be connected and thus mapped to one another. In some instances, the data structure may be further defined based on medical or veterinary literature or journals, through which recommended treatments and/or procedures for different conditions may be indicated.

At step 506, the condition determination system may determine, based on the evaluation of the digitized version of the invoice and the corresponding relevant terms using the condition data structure, whether any conditions have been definitively identified for the invoice. For instance, in order for a condition to be definitively identified from the condition data structure, the condition determination system may determine whether all of the extracted parameters from the digitized version of the invoice correspond to the condition (e.g., mapped in the data structure). For example, if the invoice processing module described above determines that all of the extracted parameters from the invoice are not mapped to a particular condition or set of conditions within the data structure, the invoice processing module may determine that a condition could not be definitively identified for the invoice using the data structure. However, if all of the extracted terms from the invoice are mapped to a particular condition or set of conditions within the data structure, the invoice processing module may associate this particular condition or set of conditions with the invoice and may accordingly, at step 516, provide the digitized version of the invoice and the identified condition or set of conditions for adjudication of the submitted claims according to the identified condition or set of conditions and any applicable insurance policies associated with the insured entity.

If the condition determination system determines that the extracted parameters associated with the digitized version of the invoice do not correspond to a particular condition, the condition determination system, at step 508, may process the digitized version of the invoice and the corresponding parameters through a keyword-based condition identification logic process. As noted above, this logic process may be implemented based on one or more automated tagging techniques, such as NER. Further, the keyword-based condition identification logic process may automatically assign a confidence score to each tag applied to the extracted terms associated with the digitized version of the invoice. This confidence score may denote a confidence level in the accuracy of the tag identification (e.g., identification of a particular condition for the invoice). For instance, a higher confidence score for a given condition tag assigned to one or more extracted terms from the invoice may denote a higher likelihood (e.g., confidence) that the condition associated with this condition tag is applicable to the invoice.

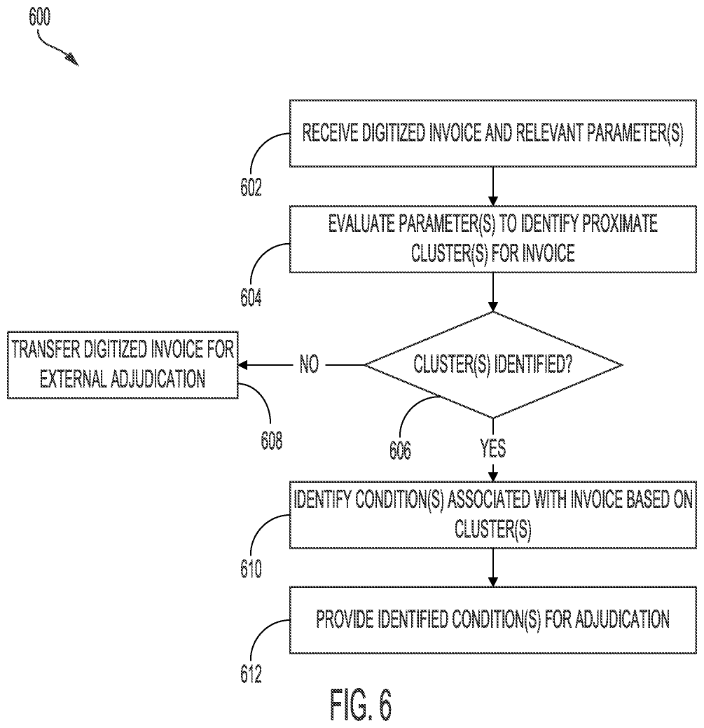

At step 510, through the implementation of the keyword-based condition identification logic process, the condition determination system may determine whether any possible conditions have been identified from the digitized version of the invoice. If execution of the keyword-based condition identification logic process does not result in any condition-based tags being applied to the digitized version of the invoice, whereby no possible conditions have been identified from the invoice, the condition determination system, at step 512, may proceed to process the digitized version of the invoice and the corresponding parameters through the aforementioned condition determination algorithm implemented by the condition determination system. The process for identifying any relevant conditions through the condition determination system is described in greater detail in connection with FIGS. 3 and 6.

If the condition determination system, through the keyword-based condition identification logic process, has identified one or more possible conditions that may be associated with the digitized version of the invoice, the condition determination system may determine, at step 514, whether the confidence score for each of these one or more possible conditions satisfies a minimum threshold score. As noted above, the identification of one or more conditions associated with a received invoice through the keyword-based condition identification logic process may be contingent on corresponding condition tags having confidence scores greater than a minimum threshold value. If a particular condition tag assigned to one or more extracted terms from the invoice has a corresponding confidence score below the pre-defined minimum threshold value, the condition determination system may automatically disregard this condition tag for the invoice. Thus, the condition associated with the condition tag may not be considered as being applicable to the invoice. However, if an applied condition tag has a corresponding confidence score that satisfies this minimum threshold value, the invoice processing module may automatically assign the condition corresponding to the applied condition tag to the invoice. If no condition tags have a confidence score that satisfies the pre-defined minimum threshold value, the condition determination system may, at step 512, process the digitized version of the invoice and the corresponding parameters through the aforementioned condition determination algorithm implemented by the condition determination system.

If the condition determination system identifies at least one condition tag that satisfies the minimum threshold value, the condition determination system may assign the condition associated with this condition tag to the invoice. Accordingly, at step 516, the condition determination system may provide the invoice and the one or more identified conditions to the claims processing system, as described above at least in connection with FIGS. 1 and 2, for adjudication of any claims associated with the invoice.

FIG. 6 shows an illustrative example of a process 600 for analyzing a digitized invoice and corresponding parameters to identify one or more proximate clusters through which one or more conditions can be identified for claim adjudication in accordance with at least one embodiment. The process 600 may be performed by the condition determination system 106 described above in connection with FIGS. 1-2. As noted above, the condition determination system may implement a condition determination algorithm 206 (as described in FIGS. 2-3) to automatically process received invoices and corresponding parameters to dynamically identify the underlying conditions associated with these invoices. Thus, certain operations of the process 600 described herein may be performed by the condition determination algorithm. Further, the process 600 may be executed in the event that the condition determination system 106 is unable to assign one or more conditions to an invoice through the aforementioned invoice processing module (e.g., the condition-based data structure and the keyword-based condition identification logic process).

At step 602, the condition determination algorithm receives a digitized version of an invoice and any relevant parameters previously extracted from the invoice. As noted above, in some instances, the keyword-based condition identification logic process may be unable to assign a condition to a received invoice. In such situations, the condition determination system may process the digitized version of the invoice through the condition determination algorithm to identify and assign one or more conditions to the digitized version of the invoice. Accordingly, the condition determination system may use the digitized version of the invoice and the corresponding parameters extracted from the invoice as input to the condition determination algorithm.

At step 604, the condition determination algorithm may evaluate the set of parameters associated with the digitized version of the invoice to identify one or more proximate clusters for the invoice. As noted above, the condition determination algorithm may be a clustering or classification algorithm that is dynamically trained, in real-time, to classify the digitized invoices and corresponding keywords according to a set of different classifications (e.g., conditions). The condition determination algorithm may perform a clustering of these parameters and obtain partial matches among clusters of digitized invoices according to one or more vectors to identify a proximate cluster for the digitized version of the invoice. These one or more vectors may correspond to different input variables from digitized versions of different invoices. These input variables may include, but are not limited to, item descriptions from the invoices (e.g., pharmaceutical entities, etc.), pet species, pet breeds, pet gender, pet age, climate zones (based on identified zip codes or other location data), rurality (based on identified zip codes or other location data), FNOL condition codes, FNOL diagnoses, previous claims, pre-existing conditions prior to insurance enrollment, and the like. The condition determination algorithm may assign values to the extracted parameters from the obtained invoice according to these one or more vectors. Through these one or more vectors, the condition determination algorithm may identify a proximate cluster for the received invoice.

At step 606, the condition determination system may determine whether one or more proximate clusters have been identified from the set of clusters defined by the condition determination algorithm. If the condition determination system determines that no clusters have been identified that are in proximity to the digitized version of the invoice along the different vectors associated with the condition determination algorithm, the condition determination system, at step 608, may transfer the digitized version of the invoice for external claims adjudication. For instance, the condition determination system may transmit the digitized version of the invoice to an adjuster queue, where the digitized version of the invoice may be accessed by a claims adjuster to manually evaluate the invoice and, based on this evaluation, adjudicate the claims associated with the invoice. In some instances, the condition determination system may automatically transfer the digitized version of the invoice for external adjudication if the condition determination algorithm associates the invoice with a proximate cluster corresponding to a special classification, whereby this special classification may be associated with other condition codes or types for which manual verification of associated claims is required.

If the condition determination algorithm associates the digitized version of the invoice with a particular cluster, the condition determination algorithm, at step 610, may identify one or more conditions associated with the invoice. As noted above, the different clusters or classifications that may be associated with the different vectors implemented by the condition determination algorithm may correspond to different condition codes or types for which the claims adjudication service may evaluate any received claims for adjudication. Thus, the different extracted terms from the invoice may be used as corresponding input values for the different vectors in order to identify a proximate cluster. This proximate cluster may denote a particular condition code or type that may be used to assign one or more conditions to the invoice.

At step 612, the condition determination system may provide the identified one or more conditions and the digitized version of the invoice to the claims processing system for adjudication of the claims associated with the invoice. In response to obtaining the digitized version of the invoice and these annotations, the claims processing system may process the provided claims to determine whether reimbursement for the expenses incurred for the treatment and/or procedures specified in the invoice may be provided.

As noted above, the condition determination algorithm may be re-trained according to feedback corresponding to the set of conditions assigned to the invoice by the condition determination algorithm. For instance, as this feedback is obtained, the condition determination algorithm may be retrained to more accurately identify conditions associated with different invoices as these invoices are received and processed. For instance, if the condition determination algorithm classified an invoice as corresponding to a particular condition, and the claims processing system determines that this classification was erroneous, the existing one or more vectors of similarity and clusters associated with the condition determination algorithm may be evaluated in order to determine whether any modifications may be performed to the one or more variables corresponding to these vectors in order to increase the likelihood of similar invoices for similar insured entities being classified according to the correct condition. The modification of these one or more variables, along with the historical data corresponding to previously processed invoices and condition assignments, may be used to perform a re-clustering of these historical invoices according to the one or more updated vectors. Thus, the condition determination algorithm may be dynamically updated to provide more accurate clustering or classification of received invoices as the claims associated with these invoices are adjudicated by the claims processing system.

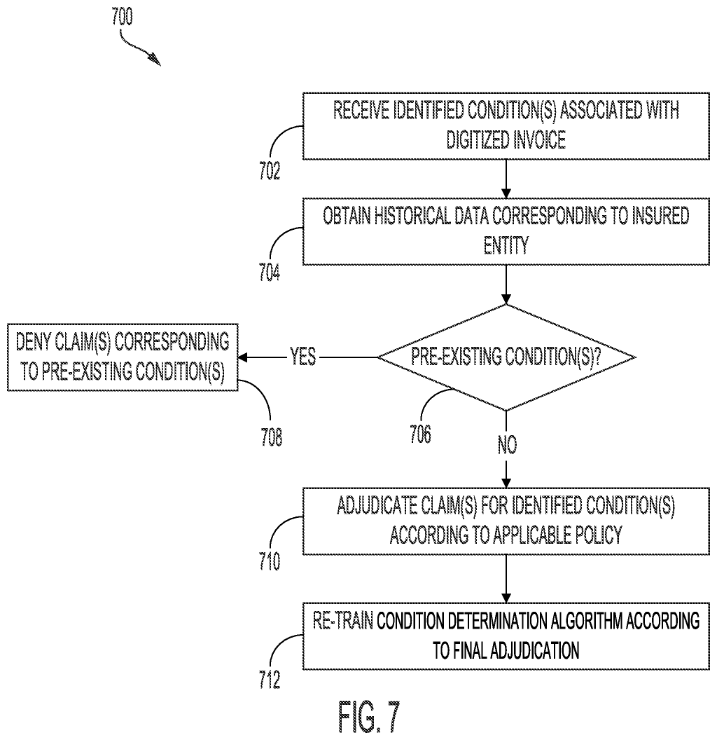

FIG. 7 shows an illustrative example of a process 700 for adjudicating one or more claims in real-time as invoices are received according to identified conditions in accordance with at least one embodiment. The process 700 may be performed by the claims processing system 108 as described above in connection with FIGS. 1-3. The claims processing system may perform the process 700 for any invoices and corresponding conditions provided by the condition determination system through the invoice processing module and/or the condition determination algorithm, as described above.

At step 702, the claims processing system may receive a digitized version of an invoice and an indication of any conditions associated with the invoice, as identified by the condition determination system. As noted above, the condition determination system may update the entry corresponding to the insured entity (or user that obtained the policy for the insured entity) in the user accounts datastore to incorporate the digitized version of the invoice and any annotations corresponding to the conditions identified from the invoice by the condition determination system. Further, the condition determination system may transmit the digitized version of the invoice and these annotations to the claims processing system. In some instances, the claims processing system may automatically, and in real-time, query the user accounts datastore to determine whether any new invoices and corresponding annotations have been added to existing insured entity entries in the user accounts datastore. If the claims processing system detects a new invoice and corresponding annotations, the claims processing system may retrieve this new invoice and corresponding annotations from the user accounts datastore for adjudication of the claims associated with this new invoice.

At step 704, the claims processing system may obtain historical data corresponding to the insured entity associated with the invoice. For instance, the claims processing system may access an entry corresponding to the insured entity and maintained in the user accounts datastore to obtain any available historical data corresponding to the insured entity. This historical data may include a historical record of received invoices, corresponding claim adjudications, diagnosed conditions, treatments/procedures performed to address the diagnosed conditions, policy information, demographic information corresponding to the insured entity, pre-existing conditions associated with the insured entity, and the like.

At step 706, the claims processing system may determine whether the one or more conditions associated with the newly received invoice correspond to any pre-existing conditions associated with the insured entity. As noted above, the insurance policy associated with an insured entity may indicate that the insured entity cannot be insured for any pre-existing conditions that were present at the time the policy went into effect. Alternatively, the insurance policy may indicate that any treatments and/or procedures performed to address a pre-existing condition may be subject to reduced benefits or reimbursement. Thus, any claims associated with a pre-existing condition may require individualized evaluation. To make this determination, the claims processing system may evaluate the historical data corresponding to the insured entity to determine whether the one or more conditions associated with the newly received invoice correspond to any pre-existing conditions associated with the insured entity. For instance, the claims processing system may review any available medical records associated with the insured entity to determine whether these medical records provide an indication of identified conditions being present prior to the effective date of the insurance policy. In some examples, the claims processing system may implement a logic process that is employed to determine whether the identified conditions are pre-existing. For instance, if the effective date of the relevant policy is within a threshold amount of time of the insured entity's birthdate, the logic process may determine that there are no prior medical records for review. Accordingly, the logic process may indicate that the identified conditions could not be pre-existing.

If the claims processing system determines that the claims associated with the newly received invoice correspond to pre-existing conditions associated with the insured entity, the claims processing system, at step 708, may automatically deny the claims corresponding to these pre-existing conditions. For instance, if the policy associated with the insured entity indicates that any treatments and/or procedures performed to address a pre-existing condition are not covered by the policy, the claims processing system may automatically deny any claim for reimbursement of expenses associated with these treatments and/or procedures performed to address the pre-existing condition. In some instances, if the applicable policy indicates that treatments and/or procedures performed to address a pre-existing condition are partially covered by the policy (e.g., the insured entity may be reimbursed for a reduced portion of expenses associated with the treatment of pre-existing conditions, etc.), the claims processing system may adjudicate any claims corresponding to the pre-existing condition according to the applicable terms of the policy.

If the claims processing system determines that the claims associated with the newly received invoice do not correspond to a pre-existing condition associated with the insured entity, the claims processing system, at step 710, may adjudicate these claims according to the applicable policy. The applicable policy may define different reimbursement parameters, whereby different reimbursement amounts or percentages may be defined for different conditions according to the insured's demographics. Thus, the claims processing system may automatically evaluate the policy according to the identified conditions and adjudicate the claims submitted with the invoice according to the policy parameters for the identified conditions, the corresponding treatments and/or procedures performed, and the expenses incurred for these treatments and/or procedures.

At step 712, the claims processing system may re-train the condition determination algorithm according to the final adjudication of the claims associated with the invoice. As noted above, as the claims processing system automatically processes and adjudicates any claims associated with received invoices according to any identified conditions and policy parameters, the claims processing system may update the user accounts datastore to indicate these adjudications. The updates performed by the claims processing system may be used to continue aggregation of statistical data corresponding to the identification of conditions for different insured entities and to the adjudication of claims associated with these identified conditions. The user accounts datastore may also be updated according to decisions resulting from appeals to claim adjudications performed by the claims processing system. Through this appeals process, insured entities may provide medical records, additional documentation from the provider of the treatment or procedure, and the like to dispute the adjudication. Based on this appeals process, it may be determined that the condition determination system has assigned the incorrect condition to a corresponding invoice previously submitted. In such instances, the claims processing system may annotate the entry correspond to the insured entity to indicate that the original condition assigned to the invoice was incorrect. Further, the claims processing system may indicate, for the invoice, the correct condition diagnosis and the corresponding adjudication resulting from the correct condition diagnosis.

As noted above, if a correction is made to an invoice to indicate the actual condition for which the indicated treatments and/or procedures were provided, the claims processing system can use this correction to update the keyword-based logic process and the condition determination algorithm to more accurately identify the conditions associated with received invoices. Returning to an earlier example, if the invoice processing module identified, using the aforementioned keyword-based logic process, a particular condition associated with a received invoice that was later determined to be erroneous, the claims processing system may use this feedback to dynamically update the keyword-based logic process such that, for similar invoices and insured entities associated with these invoices, the confidence score for the identified condition may be reduced. Additionally, the keyword-based logic process may be updated such that, for the actual condition associated with the invoice, the keyword-based logic may assign a higher confidence score to the actual condition for similar invoices and insured entities associated with these invoices. This may increase the likelihood of the actual condition being assigned to these invoices.

The claims processing system may further update, in real-time, the condition determination algorithm to more accurately identify conditions from invoices as these invoices are received and processed. For instance, if the condition determination algorithm classified an invoice as corresponding to a particular condition, and the claims processing system determines that this classification was erroneous, the claims processing system may evaluate the existing one or more vectors of similarity and clusters associated with the condition determination algorithm to modify one or more variables corresponding to these vectors in order to increase the likelihood of similar invoices for similar insured entities being classified according to the correct condition. As noted above, in some instances, the modification of these one or more variables, along with the historical data corresponding to previously processed invoices and condition assignments, may be used to perform a re-clustering of these historical invoices according to the one or more updated vectors. Accordingly, the condition determination algorithm may be dynamically updated to provide more accurate clustering or classification of received invoices as the claims associated with these invoices are adjudicated by the claims processing system.

It should be noted that the processes described above in connection with FIGS. 4-7 may be performed continuously and simultaneously for different claims and corresponding invoices as these claims and corresponding invoices are received. As noted above, the keyword-based logic process and the condition determination algorithm described above may be continuously updated in real-time as new invoices and claims are received and adjudicated by the claims adjudication service. The keyword-based logic process and the condition determination algorithm may simultaneously process different invoices and claims associated with different insured entities as these invoices and claims are received to assign different conditions to these invoices. Further, as the claims processing system adjudicates the claims corresponding to these invoices according to the assigned conditions, the condition determination system may, in real-time, update the keyword-based logic process and the condition determination algorithm to provide more accurate results. This continuous and iterative process may allow for the keyword-based logic process and the condition determination algorithm to constantly process any invoices as these invoices are received and accurately assign conditions to these invoices, which may then be used to adjudicate the claims associated with these invoices.

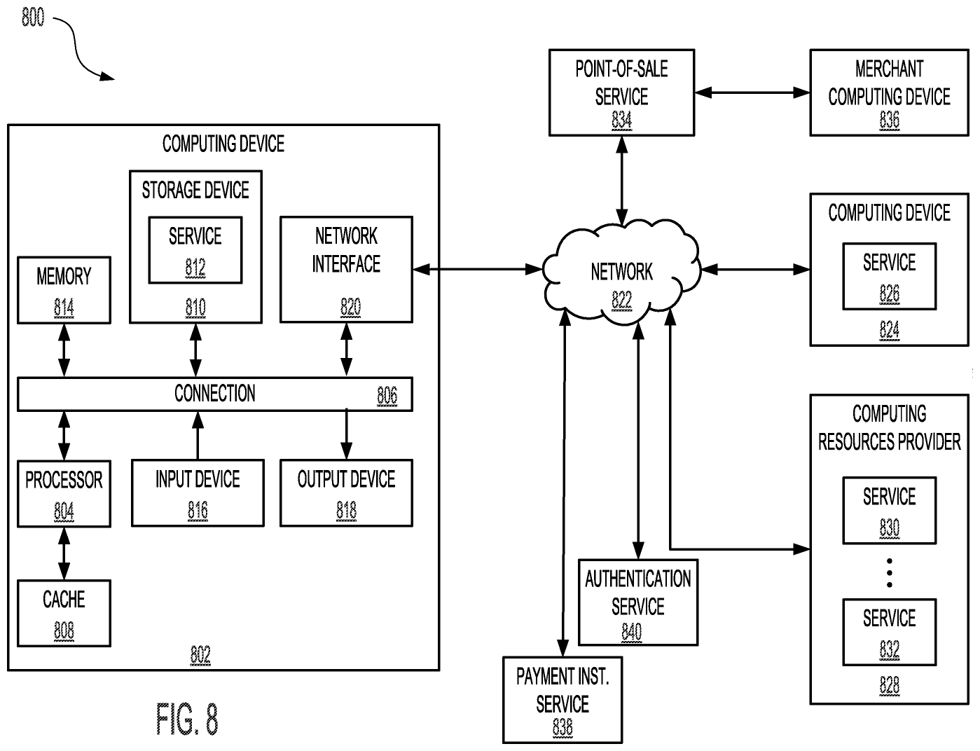

FIG. 8 illustrates a computing system architecture 800, including various components in electrical communication with each other, in accordance with some embodiments. The example computing system architecture 800 illustrated in FIG. 8 includes a computing device 802, which has various components in electrical communication with each other using a connection 806, such as a bus, in accordance with some implementations. The example computing system architecture 800 includes a processing unit 804 that is in electrical communication with various system components, using the connection 806, and including the system memory 814. In some embodiments, the system memory 814 includes read-only memory (ROM), random-access memory (RAM), and other such memory technologies including, but not limited to, those described herein. In some embodiments, the example computing system architecture 800 includes a cache 808 of high-speed memory connected directly with, in close proximity to, or integrated as part of the processor 804. The system architecture 800 can copy data from the memory 814 and/or the storage device 810 to the cache 808 for quick access by the processor 804. In this way, the cache 808 can provide a performance boost that decreases or eliminates processor delays in the processor 804 due to waiting for data. Using modules, methods and services such as those described herein, the processor 804 can be configured to perform various actions. In some embodiments, the cache 808 may include multiple types of cache including, for example, level one (L1) and level two (L2) cache. The memory 814 may be referred to herein as system memory or computer system memory. The memory 814 may include, at various times, elements of an operating system, one or more applications, data associated with the operating system or the one or more applications, or other such data associated with the computing device 802.

Other system memory 814 can be available for use as well. The memory 814 can include multiple different types of memory with different performance characteristics. The processor 804 can include any general purpose processor and one or more hardware or software services, such as service 812 stored in storage device 810, configured to control the processor 804 as well as a special-purpose processor where software instructions are incorporated into the actual processor design. The processor 804 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 804 can be a microprocessor, a microcontroller, a digital signal processor (“DSP”), or a combination of these and/or other types of processors. In some embodiments, the processor 804 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 800, an input device 816 can represent any number of input mechanisms, such as a microphone for speech, a touch-sensitive screen for gesture or graphical input, keyboard, mouse, motion input, pen, and other such input devices. An output device 818 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 800. In some embodiments, the input device 816 and/or the output device 818 can be coupled to the computing device 802 using a remote connection device such as, for example, a communication interface such as the network interface 820 described herein. In such embodiments, the communication interface can govern and manage the input and output received from the attached input device 816 and/or output device 818. As may be contemplated, there is no restriction on operating on any particular hardware arrangement and accordingly the basic features here may easily be substituted for other hardware, software, or firmware arrangements as they are developed.

In some embodiments, the storage device 810 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 810 can include hardware and/or software services such as service 812 that can control or configure the processor 804 to perform one or more functions including, but not limited to, the methods, processes, functions, systems, and services described herein in various embodiments. In some embodiments, the hardware or software services can be implemented as modules. As illustrated in example computing system architecture 800, the storage device 810 can be connected to other parts of the computing device 802 using the system connection 806. In an embodiment, a hardware service or hardware module such as service 812, that performs a function can include a software component stored in a non-transitory computer-readable medium that, in connection with the necessary hardware components, such as the processor 804, connection 806, cache 808, storage device 810, memory 814, input device 816, output device 818, and so forth, can carry out the functions such as those described herein.

The disclosed claims adjudication service, the systems of the claims adjudication service, and the systems and methods for dynamically, and in real-time, identifying one or more conditions associated with an obtained invoice can be performed using a computing system such as the example computing system illustrated in FIG. 8, using one or more components of the example computing system architecture 800. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, identifying one or more conditions associated with an obtained invoice described herein by, for example, executing code using a processor such as processor 804 wherein the code is stored in memory such as memory 814 as described herein. One or more of a user device, a provider server or system, a database system, or other such devices, services, or systems may include some or all of the components of the computing system such as the example computing system illustrated in FIG. 8, using one or more components of the example computing system architecture 800 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 828. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 804 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 814 can be coupled to the processor 804 by, for example, a connector such as connector 806, or a bus. As used herein, a connector or bus such as connector 806 is a communications system that transfers data between components within the computing device 802 and may, in some embodiments, be used to transfer data between computing devices. The connector 806 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 814 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 814 can also include magnetic or optical data storage media including read-only (e.g., CD ROM and DVD ROM) or otherwise (e.g., CD or DVD). The memory can be local, remote, or distributed.

As described herein, the connector 806 (or bus) can also couple the processor 804 to the storage device 810, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 810. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 806 can also couple the processor 804 to a network interface device such as the network interface 820. The interface can include one or more of a modem or other such network interfaces including, but not limited to those described herein. It will be appreciated that the network interface 820 may be considered to be part of the computing device 802 or may be separate from the computing device 802. The network interface 820 can include one or more of an analog modem, Integrated Services Digital Network (ISDN) modem, cable modem, token ring interface, satellite transmission interface, or other interfaces for coupling a computer system to other computer systems. In some embodiments, the network interface 820 can include one or more input and/or output (I/O) devices. The I/O devices can include, by way of example but not limitation, input devices such as input device 816 and/or output devices such as output device 818. For example, the network interface 820 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 802 can be connected to one or more additional computing devices such as computing device 824 via a network 822 using a connection such as the network interface 820. In such embodiments, the computing device 824 may execute one or more services 826 to perform one or more functions under the control of, or on behalf of, programs and/or services operating on computing device 802. In some embodiments, a computing device such as computing device 824 may include one or more of the types of components as described in connection with computing device 802 including, but not limited to, a processor such as processor 804, a connection such as connection 806, a cache such as cache 808, a storage device such as storage device 810, memory such as memory 814, an input device such as input device 816, and an output device such as output device 818. In such embodiments, the computing device 824 can carry out the functions such as those described herein in connection with computing device 802. In some embodiments, the computing device 802 can be connected to a plurality of computing devices such as computing device 824, each of which may also be connected to a plurality of computing devices such as computing device 824. Such an embodiment may be referred to herein as a distributed computing environment.

The network 822 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 822 can be wired connections, wireless connections, or combinations thereof. Communications via the network 822 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 822, within the computing device 802, within the computing device 824, or within the computing resources provider 828 can include information, which also may be referred to herein as content. The information may include text, graphics, audio, video, haptics, and/or any other information that can be provided to a user of the computing device such as the computing device 802. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 802 and presented to a user of the computing device 802 using forms that are perceptible via sight, sound, smell, taste, touch, or other such mechanisms. In some embodiments, communications over the network 822 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 802 and/or the computing device 824 can be connected to a computing resources provider 828 via the network 822 using a network interface such as those described herein (e.g. network interface 820). In such embodiments, one or more systems (e.g., service 830 and service 832) hosted within the computing resources provider 828 (also referred to herein as within “a computing resources provider environment”) may execute one or more services to perform one or more functions under the control of, or on behalf of, programs and/or services operating on computing device 802 and/or computing device 824. Systems such as service 830 and service 832 may include one or more computing devices such as those described herein to execute computer code to perform the one or more functions under the control of, or on behalf of, programs and/or services operating on computing device 802 and/or computing device 824.

For example, the computing resources provider 828 may provide a service, operating on service 830 to store data for the computing device 802 when, for example, the amount of data that the computing device 802 exceeds the capacity of storage device 810. In another example, the computing resources provider 828 may provide a service to first instantiate a virtual machine (VM) on service 832, use that VM to access the data stored on service 832, perform one or more operations on that data, and provide a result of those one or more operations to the computing device 802. Such operations (e.g., data storage and VM instantiation) may be referred to herein as operating “in the cloud,” “within a cloud computing environment,” or “within a hosted virtual machine environment,” and the computing resources provider 828 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 828 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 830 and service 832 may implement versions of various services (e.g., the service 812 or the service 826) on behalf of, or under the control of, computing device 802 and/or computing device 824. Such implemented versions of various services may involve one or more virtualization techniques so that, for example, it may appear to a user of computing device 802 that the service 812 is executing on the computing device 802 when the service is executing on, for example, service 830. As may also be contemplated, the various services operating within the computing resources provider 828 environment may be distributed among various systems within the environment as well as partially distributed onto computing device 824 and/or computing device 802.

In an embodiment, the computing device 802 can be connected to one or more additional computing devices and/or services such as merchant computing device 836 and/or a point-of-sale service 834 via the network 822 and using a connection such as the network interface 820. In an embodiment, the point-of-sale service 834 is separate from the merchant computing device 836. In an embodiment, the point-of-sale service 834 is executing on the merchant computing device 836. In an embodiment, the point-of-sale service 834 is executing as one or more services (e.g., the service 830 and/or the service 832) operating within the environment of the computing resources provider. As used herein, a point-of-sale service 834 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 836 to interact with the point-of-sale service 834. In an embodiment, the merchant computing device 836 is a dedicated point-of-service (POS) terminal. In an embodiment, the merchant computing device 836 is a cash register system. In an embodiment, the merchant computing device 836 is an application or web service operating on a computing device such as the computing device 802 described herein. In such an embodiment, the application or web service may be provided by a financial services system (e.g., a bank, a transaction processing system, an inventory management system, or some other such financial services system). In an embodiment, the merchant computing device 836 includes an auxiliary device or system to execute tasks associated with the point-of-sale service 834 (e.g., a payment instrument processing device attached to a smart phone or tablet). In an embodiment, the merchant computing device 836 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 836 is a virtual device (e.g., a virtual kiosk) such as the virtual devices described herein. Although not illustrated here, in an embodiment, the merchant computing device 836 may be one of a plurality of devices that may be interconnected using a network such as the network 822.

In an embodiment, the computing device 802 can be connected to one or more additional computing devices and/or services such as a payment instrument service 838 via the network 822 and using a connection such as the network interface 820. In an embodiment, the payment instrument service 838 connects directly with the point of sale service 834. In an embodiment, elements of the payment instrument service 838 are executing on the merchant computing device 836. In an embodiment, the payment instrument service 838 is executing as one or more services (e.g., the service 830 and/or the service 832) operating within the environment of the computing resources provider. As used herein, a payment instrument service 838 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 838 are running as an application or web service operating on a computing device such as the computing device 802 described herein. In such an embodiment, the application or web service of the payment instrument service 838 may be provided by a financial services system (e.g., a bank, a transaction processing system, an inventory management system, or some other such financial services system). In an embodiment, elements of the payment instrument service 838 are running on an auxiliary device or system configured to execute tasks associated with the payment instrument service 838 (e.g., uses a payment instrument processing device attached to a smart phone or tablet). In an embodiment, elements of the payment instrument service 838 are running on virtual device such as those described herein. Although not illustrated here, in an embodiment, the payment instrument service 838 may be running on one or more of a plurality of devices that may be interconnected using a network such as the network 822.

In an embodiment, the computing device 802 can be connected to one or more additional computing devices and/or services such as an authentication service 840 via the network 822 and using a connection such as the network interface 820. In an embodiment, the authentication service 840 is an element of the payment instrument service 838. In an embodiment, the authentication service 840 is separate from the payment instrument service 838. In an embodiment, the authentication service 840 connects directly with the point of sale service 834. In an embodiment, elements of the authentication service 840 are executing on the merchant computing device 836. In an embodiment, the authentication service 840 is executing as one or more services (e.g., the service 830 and/or the service 832) operating within the environment of the computing resources provider. As used herein, an authentication service 840 is a service used by one or more merchants to authenticate transactions associated with payment instruments. An authentication service may be a third-party service that provides secure and verified authorization of the transactions.

In an embodiment, elements of the authentication service 840 are running as an application or web service operating on a computing device such as the computing device 802 described herein. In such an embodiment, the application or web service of the authentication service 840 may be provided by a financial services system (e.g., a bank, a transaction processing system, an inventory management system, or some other such financial services system). In an embodiment, elements of the authentication service 840 are running on an auxiliary device or system configured to execute tasks associated with the authentication service 840 (e.g., provides authentication using payment instrument processing device attached to a smart phone or tablet). In an embodiment, elements of the authentication service 840 are running on virtual device such as those described herein. Although not illustrated here, in an embodiment, the authentication service 840 may be running on one or more of a plurality of devices that may be interconnected using a network such as the network 822.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 802) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 802.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving an invoice associated with an insured entity, wherein the invoice indicates a set of procedures performed for treatment of the insured entity, and wherein the insured entity is associated with a policy;
generating a digitized version of the invoice, wherein the digitized version of the invoice is generated according to a machine-readable format;
dynamically training a machine learning algorithm to identify one or more conditions associated with the invoice, wherein the machine learning algorithm is dynamically trained using a dataset of historical invoices and corresponding conditions;
identifying the one or more conditions associated with the invoice, wherein the one or more conditions are identified through the machine learning algorithm using the digitized version of the invoice;
generating an adjudication of a set of claims associated with the invoice, wherein the adjudication is generated based on the one or more conditions and the policy; and
updating the machine learning algorithm using the invoice, the one or more conditions, and the adjudication.

2. The computer-implemented method of claim 1, wherein the digitized version of the invoice is generated using an optical character recognition (OCR) process.

3. The computer-implemented method of claim 1, wherein the adjudication includes a rejection of the set of claims, and wherein the rejection of the set of claims is generated as a result of the one or more conditions corresponding to a set of pre-existing conditions associated with the insured entity.

4. The computer-implemented method of claim 1, further comprising:
applying a logic process to the digitized version of the invoice to obtain a set of condition tags corresponding to different conditions, wherein the set of condition tags are associated with a set of confidence scores; and
processing the digitized version of the invoice through the machine learning algorithm as a result of the set of confidence scores failing to satisfy a minimum threshold value.

5. The computer-implemented method of claim 1, wherein the one or more conditions are identified through identification of a proximate cluster from a set of clusters, wherein the proximate cluster corresponds to the one or more conditions, and wherein the proximate cluster is identified according to a set of vector values corresponding to parameters associated with the invoice.

6. The computer-implemented method of claim 1, wherein the machine learning algorithm is further updated according to modifications made to previous adjudications resulting from appeals made to the previous adjudications.

7. The computer-implemented method of claim 1, wherein updating the machine learning algorithm includes modifying one or more variables corresponding to a set of vectors of similarity corresponding to parameters associated with the historical invoices according to the adjudication.

8. A system, comprising:
one or more processors; and
memory storing thereon instructions that, as a result of being executed by the one or more processors, cause the system to:
receive an invoice associated with an insured entity, wherein the invoice indicates a set of procedures performed for treatment of the insured entity, and wherein the insured entity is associated with a policy;
generate a digitized version of the invoice, wherein the digitized version of the invoice is generated according to a machine-readable format;
dynamically train a machine learning algorithm to identify one or more conditions associated with the invoice, wherein the machine learning algorithm is dynamically trained using a dataset of historical invoices and corresponding conditions;
identify the one or more conditions associated with the invoice, wherein the one or more conditions are identified through the machine learning algorithm using the digitized version of the invoice;
generate an adjudication of a set of claims associated with the invoice, wherein the adjudication is generated based on the one or more conditions and the policy; and
update the machine learning algorithm using the invoice, the one or more conditions, and the adjudication.

9. The system of claim 8, wherein the digitized version of the invoice is generated using an optical character recognition (OCR) process.

10. The system of claim 8, wherein the adjudication includes a rejection of the set of claims, and wherein the rejection of the set of claims is generated as a result of the one or more conditions corresponding to a set of pre-existing conditions associated with the insured entity.

11. The system of claim 8, wherein the instructions further cause the system to:
apply a logic process to the digitized version of the invoice to obtain a set of condition tags corresponding to different conditions, wherein the set of condition tags are associated with a set of confidence scores; and
process the digitized version of the invoice through the machine learning algorithm as a result of the set of confidence scores failing to satisfy a minimum threshold value.

12. The system of claim 8, wherein the one or more conditions are identified through identification of a proximate cluster from a set of clusters, wherein the proximate cluster corresponds to the one or more conditions, and wherein the proximate cluster is identified according to a set of vector values corresponding to parameters associated with the invoice.

13. The system of claim 8, wherein the machine learning algorithm is further updated according to modifications made to previous adjudications resulting from appeals made to the previous adjudications.

14. The system of claim 8, wherein the instructions that cause the system to update the machine learning algorithm further cause the system to:
modify one or more variables corresponding to a set of vectors of similarity corresponding to parameters associated with the historical invoices according to the adjudication.

15. A non-transitory computer-readable storage medium storing thereon executable instructions that, as a result of being executed by one or more processors of a computer system, cause the computer system to:
receive an invoice associated with an insured entity, wherein the invoice indicates a set of procedures performed for treatment of the insured entity, and wherein the insured entity is associated with a policy;
generate a digitized version of the invoice, wherein the digitized version of the invoice is generated according to a machine-readable format;
dynamically train a machine learning algorithm to identify one or more conditions associated with the invoice, wherein the machine learning algorithm is dynamically trained using a dataset of historical invoices and corresponding conditions;
identify the one or more conditions associated with the invoice, wherein the one or more conditions are identified through the machine learning algorithm using the digitized version of the invoice;
generate an adjudication of a set of claims associated with the invoice, wherein the adjudication is generated based on the one or more conditions and the policy; and
update the machine learning algorithm using the invoice, the one or more conditions, and the adjudication.

16. The non-transitory computer-readable storage medium of claim 15, wherein the digitized version of the invoice is generated using an optical character recognition (OCR) process.

17. The non-transitory computer-readable storage medium of claim 15, wherein the adjudication includes a rejection of the set of claims, and wherein the rejection of the set of claims is generated as a result of the one or more conditions corresponding to a set of pre-existing conditions associated with the insured entity.

18. The non-transitory computer-readable storage medium of claim 15, wherein the executable instructions further cause the computer system to:
apply a logic process to the digitized version of the invoice to obtain a set of condition tags corresponding to different conditions, wherein the set of condition tags are associated with a set of confidence scores; and
process the digitized version of the invoice through the machine learning algorithm as a result of the set of confidence scores failing to satisfy a minimum threshold value.

19. The non-transitory computer-readable storage medium of claim 15, wherein the one or more conditions are identified through identification of a proximate cluster from a set of clusters, wherein the proximate cluster corresponds to the one or more conditions, and wherein the proximate cluster is identified according to a set of vector values corresponding to parameters associated with the invoice.

20. The non-transitory computer-readable storage medium of claim 15, wherein the machine learning algorithm is further updated according to modifications made to previous adjudications resulting from appeals made to the previous adjudications.

21. The non-transitory computer-readable storage medium of claim 15, wherein the executable instructions that cause the computer system to update the machine learning algorithm further cause the computer system to:
modify one or more variables corresponding to a set of vectors of similarity corresponding to parameters associated with the historical invoices according to the adjudication.
